(19) United States
(12) Patent Application Publication
(10) Pub. No.: US 2018/0043654 A1
(43) Pub. Date: Feb. 15, 2018

(54) SINGLE FOIL RIBBED SHEET, METHOD AND APPARATUS OF MAKING SAME AND PRODUCTS PRODUCED THEREWITH

(71) Applicant: Bradford Company, Holland, MI (US)

(72) Inventor: Judson A. Bradford, Holland, MI (US)

(21) Appl. No.: 15/677,729

(22) Filed: Aug. 15, 2017

Related U.S. Application Data
(60) Provisional application No. 62/375,229, filed on Aug. 15, 2016.

(51) Int. Cl. B32B 3/28; B32B 15/01; B29C 47/00

(52) U.S. Cl. CPC B32B 3/28; B29C 47/0026; B32B 15/01

(57) ABSTRACT

A single-foil ribbed sheet product includes a single-foil ribbed sheet formed from an opposed-foil panel having first and second spaced apart planar foils and a plurality of support members affixed to and defining a height between opposed interior surfaces of the spaced apart first and second planar foils, by severing at least the second planar foil from the opposed-foil panel along a plane parallel with a plane defined by the first and second planar foils to produce the single-foil ribbed sheet comprising the first planar foil and some or all of the height of the plurality of support members extending away from the interior surface thereof, and a product made from one or more such single-foil ribbed sheets.

### CROSS-REFERENCE TO RELATED U.S. APPLICATION

This application claims the benefit of, and priority to, U.S. Patent Application No. 62/375,229, filed Aug. 15, 2016, the disclosure of which is incorporated herein by reference in its entirety.

### FIELD OF THE INVENTION

The present invention relates generally to pre-fabricated, rigid or semi-rigid opposing-foil panels, and more specifically to apparatuses and methods for processing such panels to form ribbed sheets and products produced therewith.

### BACKGROUND

Conventional opposing-foil panels are used to construct various panel products including, for example, collapsible container sleeves for shipping and/or storage of one or more items, single and multi-cell partitions and other panel products. Some such panels may be extruded and include a number of integral, spaced-apart and typically elongated structures interconnecting the opposing foils, wherein the opposing foils and the interconnecting structures are of unitary construction. Other such panels may include a separate, inner foil laminated to and between the opposing foils, wherein the inner foil is typically shaped into a number of spaced-apart interconnecting structures alternatingly affixed to the inner surfaces of the opposing foils.

Due, at least in part, to their construction and/or various physical properties, conventional opposing-foil panels are ill-suited for some applications, and in others such panels typically require additional, costly processing and/or fabrication to produce suitable panel products. It is desirable to expand the range of panel products for which conventional opposing-foil panels may be used and/or to reduce the cost, additional processing and/or additional fabrication typically required in order to produce existing panel products.

### SUMMARY

The present invention may comprise one or more of the features recited in the attached claims, and/or one or more of the following features and combinations thereof. In a first example aspect, a method for making single-foil ribbed sheets may comprise providing an opposed-foil panel having first and second spaced apart planar foils and a plurality of support members affixed to and between opposed interior surfaces of the spaced apart first and second planar foils such that the plurality of support members define a height between the opposed interior surfaces, positioning at least one of the opposed-foil panel and a cutting tool, including a blade defining a cutting edge, relative to the other such that at least a portion of the blade extends along a blade plane parallel with planes defined by the first and second planar foils and passing through the plurality of support members or an interface between the plurality of support members and one of the first and second planar foils, and moving at least one of the cutting tool and the opposed-foil panel such that the cutting edge of the blade passes through the blade plane to produce at least one single-foil ribbed sheet including one of the first and second planar foils and at least a portion of the height of the support members extending away from the interior surface thereof.

A second example aspect includes the subject matter of the first example aspect, and wherein the positioning step comprises positioning the at least one of the opposed-foil panel the cutting tool relative to each other such that the blade plane passes through the interface between the plurality of support members and the second planar foil, and moving the at least one of the cutting tool and the opposed-foil panel produces a single-foil ribbed sheet including the first planar foil and all or most of the height of the plurality of support members extending away from the interior surface thereof.

A third example aspect includes the subject matter of the first example aspect, and wherein the positioning step comprises positioning the at least one of the opposed-foil panel and the cutting tool relative to the other such that the blade plane passes through the plurality of support members between the first and second planar foils, and moving the at least one of the cutting tool and the opposed-foil panel produces two single-foil ribbed sheets each including one of the first and second planar foils and at least a portion of the height of the support members extending away from the interior surface thereof.

A fourth example aspect includes the subject matter of either of any of the first through third example aspects, and wherein the portion of the blade that extends along the blade plane spans the opposed-foil panel, and moving the at least one of the cutting tool and the opposed-foil panel produces the at least one single-foil ribbed sheet in a single pass of the blade through the blade plane.

A fifth example aspect includes the subject matter of either of any of the first through fourth example aspects, and wherein the plurality of support members extend in a machine direction along and between the interior surfaces of the first and second planar foils and are spaced apart along a cross-machine direction normal to the machine direction, and wherein the positioning step comprises positioning the at least one of the opposed-foil panel and the cutting tool relative to the other such that moving the at least one of the cutting tool and the opposed-foil panel causes the at least one of the cutting tool and the opposed-foil panel to move toward the other along the machine direction, and wherein the method further comprises driving the cutting edge of the blade along the blade plane in the cross-machine direction as the cutting edge of the blade passes through the blade plane along the machine direction to produce the at least one single-foil ribbed sheet.

In a sixth example aspect, a single-foil ribbed sheet product may comprise a single-foil ribbed sheet formed from an opposed-foil panel having first and second spaced apart planar foils and a plurality of support members affixed to and defining a height between opposed interior surfaces of the spaced apart first and second planar foils, by severing at least the second planar foil from the opposed-foil panel along a plane parallel with a plane defined by the first and second planar foils to produce the single-foil ribbed sheet comprising the first planar foil and some or all of the height of the plurality of support members extending away from the interior surface thereof, and a product made from one or more of the single-foil ribbed sheet.

A seventh example aspect includes the subject matter of the sixth example aspect, and wherein the plurality of support members of the single-foil ribbed sheet comprises a plurality of elongated support members extending in a first direction along the interior surface of the first planar foil and spaced apart along a second direction normal to the first direction, and wherein the product is a fluid directing apparatus comprising a body defining a surface with an exterior surface, opposite the interior surface, of the first planar foil mounted thereto such that the some or all of the height of the plurality of support members extending away from the interior surface of the first planar foil define elongated channels between the spaced apart support members to direct fluid flow therethrough along the surface of the body.

An eighth example aspect includes the subject matter of the sixth example aspect, and wherein the plurality of support members of the single-foil ribbed sheet comprises a plurality of elongated support members extending in a first direction along the interior surface of the first planar foil and spaced apart along a second direction normal to the first direction, each of the plurality of support members extending away from the interior surface of the first planar foil to an exposed terminal surface, and wherein the product is a fluid directing apparatus comprising a body defining a surface with the exposed terminal surfaces of the plurality of elongated support members mounted thereto to define elongated, closed channels between the spaced apart support members, the interior surface of the first planar foil and the surface of the body to direct fluid flow therethrough.

A ninth example aspect includes the subject matter of the sixth example aspect, and wherein the first planar foil is a flexible planar foil and each of the plurality of support members extend away from the interior surface of the flexible planar foil to an exposed terminal surface, and wherein the product is a flexible packing mat for protecting a cylindrical object during shipping or storage, the flexible packing mat comprising the flexible planar foil sized to wrap about the cylindrical object with the exposed terminal surfaces of the plurality of support members in contact with the cylindrical object such that the flexible planar foil is spaced apart from the cylindrical object by the plurality of support members.

A tenth example aspect includes the subject matter of the ninth example aspect, and wherein the flexible planar foil of the flexible packing mat defines a first side and a second side opposite the first side, and wherein the first and second sides are joined together at least partially along a length thereof with the flexible packing mat wrapped about the cylindrical object to secure the flexible packing mat about the cylindrical object.

An eleventh example aspect includes the subject matter of the sixth example aspect, and wherein the opposed-foil panel from which the single-foil ribbed sheet is formed is made of plastic, and wherein the first planar foil is a flexible planar foil and each of the plurality of support members extend away from the interior surface of the flexible planar foil and wherein the product is a supportable divider for separating items during shipping or storage, the supportable divider comprising the single-foil ribbed sheet folded along a fold line defined along the flexible planar foil to produce opposing flaps on either side of the fold line with each flap having an interior surface defined by the interior surface of a respective portion of the flexible planar foil defining the flap and with the interior surfaces of the opposing flaps facing each other, the interior surfaces of the opposing flaps thermally bonded together at one or more locations leaving an opening adjacent to and along the fold line which extends completely through the folded, single-foil ribbed sheet, the opening sized to receive an elongated support member therethrough for supporting the supportable divider.

A twelfth example aspect includes the subject matter of the eleventh example aspect, and wherein the plurality of support members of the single-foil ribbed sheet comprises a plurality of elongated support members extending in a first direction along the interior surface of the first planar foil and spaced apart along a second direction normal to the first direction.

A thirteenth example aspect includes the subject matter of either of the eleventh and twelfth example aspects, and wherein the opposing flaps are pressed together in contact at one or more locations thereof such that the plurality of support members extending away from the interior surfaces of each flap interdigitate, the opposing flaps thermally bonded together at the one or more locations by thermally bonding at least corresponding ones of the plurality of interdigitated support members at the one or more locations to the interior surfaces of the opposing flaps.

A fourteenth example aspect includes the subject matter of any of the eleventh through thirteenth example aspects, and wherein a length of the divider is defined by cutting opposing ends of the single-foil panel, after folding the single-foil ribbed sheet along the fold line, with a cutting tool which generates sufficient heat during cutting of the opposed flaps together to thermally bond the opposed flaps along at least portions of opposing ends thereof.

A fifteenth example aspect includes the subject matter of any of the eleventh through fourteenth example aspects, and further comprising the elongated support member extending through the opening of the supportable divider, the elongated support member supportable at either end thereof or at or near the opposing sides of the divider such that the supportable divider is suspended by the elongated support member.

A sixteenth example aspect includes the subject matter of the sixth example aspect, and wherein the opposed-foil panel from which the single-foil ribbed sheet is formed is made of plastic, and wherein the first planar foil is a flexible planar foil and each of the plurality of support members extend away from the interior surface of the flexible planar foil, and wherein the product is an object storage or transport sleeve for supporting items during shipping or storage, the sleeve comprising the single-foil ribbed sheet folded along a first fold line defined along the flexible planar foil and along a second fold line defined along the flexible planar foil and parallel with and spaced apart from the first fold line to form a first flap between the first fold line and one end of the single-foil ribbed sheet and a second flap between the second fold line and an opposite end of the single-foil ribbed sheet, the first flap having an interior surface defined by the interior surface of a portion of the flexible planar foil defining the first flap, the second flap having an interior surface defined by the interior surface of a portion of the flexible planar foil defining the second flap, and with the interior surface of the first flap facing a first portion of the interior surface of the flexible planar foil between the first and second fold lines and the interior surface of the second flap facing a second portion of the interior surface of the flexible planar foil between the first and second fold lines adjacent to the first portion of the interior surface of the flexible planar foil, the interior surfaces of the first flap and the first portion of the flexible planar foil thermally bonded together at one or more locations leaving a first opening adjacent to and along the first fold line which extends completely through the folded single-foil ribbed sheet, the first opening sized to receive a first elongated support member therethrough for supporting the object storage or transport sleeve, and the interior surfaces of the second flap and the second portion of the flexible planar foil thermally bonded together at one or more locations leaving a second opening adjacent to and along the second fold line which extends completely through the folded, single-foil ribbed sheet, the second opening sized to receive a second elongated support member therethrough for supporting the object storage or transport sleeve.

A seventeenth example aspect includes the subject matter of the sixteenth example aspect, and further comprising the first and second elongated support members each extending through a corresponding one of the first and second openings of the object storage or transport sleeve, each of the pair of elongated support members supportable at either end thereof or at or near the opposing sides of the sleeve such that the sleeve is suspended by the pair of elongated support members.

An eighteenth example aspect includes the subject matter of either of the sixteenth or seventeenth example aspects, and wherein the first flap and the first portion of the flexible planar foil are pressed together in contact at one or more locations thereof such that the plurality of support members extending away from the interior surfaces thereof interdigitate, the first flap and the first portion of the flexible planar foil thermally bonded together at one or more first locations by thermally bonding at least corresponding ones of the plurality of interdigitated support members at the one or more first locations to the interior surfaces of the first flap and the first portion of the flexible planar foil, and wherein the second flap and the second portion of the flexible planar foil are pressed together in contact at one or more locations thereof such that the plurality of support members extending away from the interior surfaces thereof interdigitate, the second flap and the second portion of the flexible planar foil thermally bonded together at one or more second locations by thermally bonding at least corresponding ones of the plurality of interdigitated support members at the one or more second locations to the interior surfaces of the second flap and the second portion of the flexible planar foil.

A nineteenth example aspect includes the subject matter of the sixth example aspect, and wherein the opposed-foil panel from which the single-foil ribbed sheet is formed is made of plastic, and wherein the first planar foil is a flexible planar foil and each of the plurality of support members extend away from the interior surface of the flexible planar foil, and wherein the product is a partition structure for separating items during shipping or storage, the partition structure comprising a first single-foil ribbed sheet folded along a first fold line to produce opposing first flaps on either side of the first fold line with each first flap having an interior surface defined by the interior surface of a respective portion of the flexible planar foil defining the first flap and with the interior surfaces of the opposing first flaps facing each other, the first single-foil ribbed sheet defining an opening therethrough adjacent to the first fold line and a first slot therethrough aligned with and extending toward the opening from opposed free ends of the opposing first flaps, and a second single-foil ribbed sheet folded along a second fold line to produce second opposing flaps on either side of the second fold line with each second flap having an interior surface defined by the interior surface of a respective portion of the flexible planar foil defining the second flap and with the interior surfaces of the opposing second flaps facing each other, the second single-foil ribbed sheet defining a second slot therethrough extending through and from the second fold line toward the opposed free ends of the opposing second flaps, wherein the second slot of the second single-foil ribbed sheet is received within the first slot of first single-foil ribbed sheet such that the opening through the first single-foil ribbed sheet aligns with the interior surfaces of the opposed second flaps of the second single-foil ribbed sheet adjacent to the second fold line, the opening sized to receive therethrough, and also along and within the aligned second single-foil ribbed sheet adjacent to the second fold line, an elongated support member for supporting the partition.

A twentieth example aspect includes the subject matter of the nineteenth example aspect, and wherein at least one of the first opposing flaps and the second opposing flaps are not attached to each other such that the at least one of the corresponding first and second single-foil ribbed sheets forms a billowed divider.

### BRIEF DESCRIPTION OF THE DRAWINGS

FIG. 1A is a simplified diagram showing a perspective view of one embodiment of an apparatus for processing an opposing-foil panel to produce two single-foil ribbed sheets.

FIG. 1B is a simplified diagram similar to FIG. 1A showing the apparatus processing the opposing-foil panel to produce two single-foil ribbed sheets.

FIG. 2A is a cross-sectional view of the opposing-foil panel of FIG. 1A along the section lines 1A-1A.

FIG. 2B is a simplified cross-sectional view of the opposing-foil panel of FIG. 2A after processing by the apparatus of FIGS. 1A and 1B to form two single-foil ribbed sheets having substantially identical rib heights.

FIG. 2C is a simplified cross-sectional view of the opposing-foil panel of FIG. 2A after processing by the apparatus of FIGS. 1A and 1B to form two single-foil ribbed sheets having different rib heights.

FIG. 3A is a simplified cross-sectional view of another example embodiment of an opposing-foil panel that may be processed by the apparatus of FIGS. 1A and 1B to produce two single-foil ribbed sheets.

FIG. 3B is a simplified cross-sectional view of yet another example embodiment of an opposing-foil panel that may be processed by the apparatus of FIGS. 1A and 1B to produce two single-foil ribbed sheets.

FIG. 3C is a simplified cross-sectional view of still another example embodiment of an opposing-foil panel that may be processed by the apparatus of FIGS. 1A and 1B to produce two single-foil ribbed sheets.

FIG. 3D is a simplified cross-sectional view of a further example embodiment of an opposing-foil panel that may be processed by the apparatus of FIGS. 1A and 1B to produce two single-foil ribbed sheets.

FIG. 3E is a simplified cross-sectional view of yet a further example embodiment of an opposing-foil panel that may be processed by the apparatus of FIGS. 1A and 1B to produce two single-foil ribbed sheets.

FIG. 4A is a simplified cross-sectional view of one of the single-foil ribbed sheets of FIG. 2B implemented in a first example product.

FIG. 4B is a simplified cross-sectional view of one of the single-foil ribbed sheets of FIG. 2C implemented in a second example product.

FIG. 4C is a simplified cross-sectional view of one of the single-foil ribbed sheets of FIG. 2B implemented in another example product.

FIGS. 5A and 5B are simplified perspective and end views respectively of one of the single-foil ribbed sheets of FIG. 2B folded along a line parallel to the ribs.

FIG. 5C is a simplified end view of the single-foil ribbed sheet of FIGS. 5A and 5B processed using one embodiment of a sheet bonding apparatus to produce a third example product in the form of a supportable partition.

FIGS. 5D and 5E are simplified elevated side and end views respectively of the single-foil ribbed sheet of FIGS. 5A and 5B processed using another embodiment of a sheet bonding apparatus to produce the third example product.

FIGS. 5F and 5G are simplified perspective and end views respectively of the single-foil ribbed sheet of FIGS. 5A and 5B processed using yet another embodiment of a sheet bonding apparatus to produce the third example product.

FIG. 5H is a simplified side elevational view of the third example product supported by an elongated support member.

FIG. 6A is a simplified perspective view of one of the single-foil ribbed sheets of FIG. 2B folded along a line normal to the ribs.

FIG. 6B is a simplified end view of the single-foil ribbed sheet of FIG. 6A with the flaps of the sheet on either side of the fold pressed together such that the ribs interdigitate.

FIG. 6C is a simplified side elevational view of the single-foil ribbed sheet of FIGS. 6A and 6B processed using any of the embodiments of the sheet bonding apparatus illustrated in FIGS. 5C-5G to produce a fourth example product in the form of a supportable partition supported by an elongated support member.

FIG. 7A is an end view of one of the single-foil ribbed sheets of FIG. 2B processed to produce a fifth example product in the form of a supportable sleeve or pocket.

FIG. 7B is a perspective view of the supportable sleeve or pocket of FIG. 7A supported by a pair of elongated support members.

FIG. 8A is a simplified elevated side view of one of the single-foil ribbed sheets of FIG. 2B folded along a line parallel to the ribs and processed to produce part of a sixth example product in the form of a billowed partition wall.

FIG. 8B is a simplified elevated side view of another one of the single-foil ribbed sheets of FIG. 2B folded along a line parallel to the ribs and processed to produce another part of the sixth example product in the form of another billowed partition wall.

FIG. 8C is a perspective view of the sixth example product in the form of a billowed partition with the billowed partition walls of FIGS. 8A and 8B coupled together via an elongated coupling member.

FIG. 8D is a perspective view of a seventh example product, similar to the sixth example product, in the form of a partition with the sheets of the partition walls of FIGS. 8A and 8B bonded together prior to assembly of the partition.

FIG. 9A is a simplified elevated side view of one of the single-foil ribbed sheets of FIG. 2B folded along a line parallel to the ribs and processed to produce part of an eighth example product in the form of a partition wall.

FIG. 9B is a simplified elevated side view of another one of the single-foil ribbed sheets of FIG. 2B folded along a line parallel to the ribs and processed to produce another part of the eighth example product in the form of another partition wall.

FIG. 9C is a perspective view of the eighth example product in the form of a partition with the partition walls of FIGS. 9A and 9B coupled together via one of the partition wall interconnecting slots formed in each.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same. For purposes of this disclosure, the term “opposing-foil panel” is defined a panel of unitary construction, extruded or otherwise, having two opposing planar foils with integral support structures extending between and interconnecting inwardly facing surfaces of the two opposing foils along their length, across their width and periodically spaced apart along at least one of their length or width, or a laminated panel having an inner foil shaped into periodically spaced apart support structures alternatingly affixed to and between inwardly facing surfaces of two opposing foils along their length and across their width. The term “single-foil ribbed sheet” is defined for purposes of this disclosure as a single foil having unitary or laminated structures extending away from one face thereof along its length, across its width and spaced apart along at least one of its length or width.

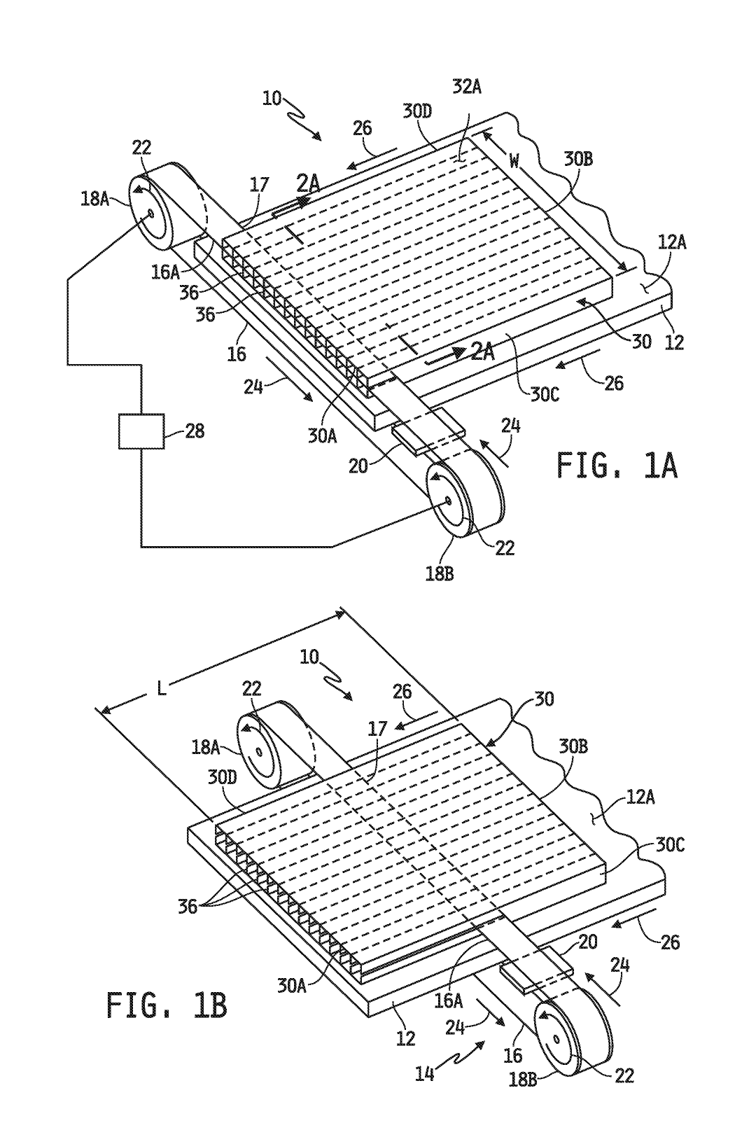

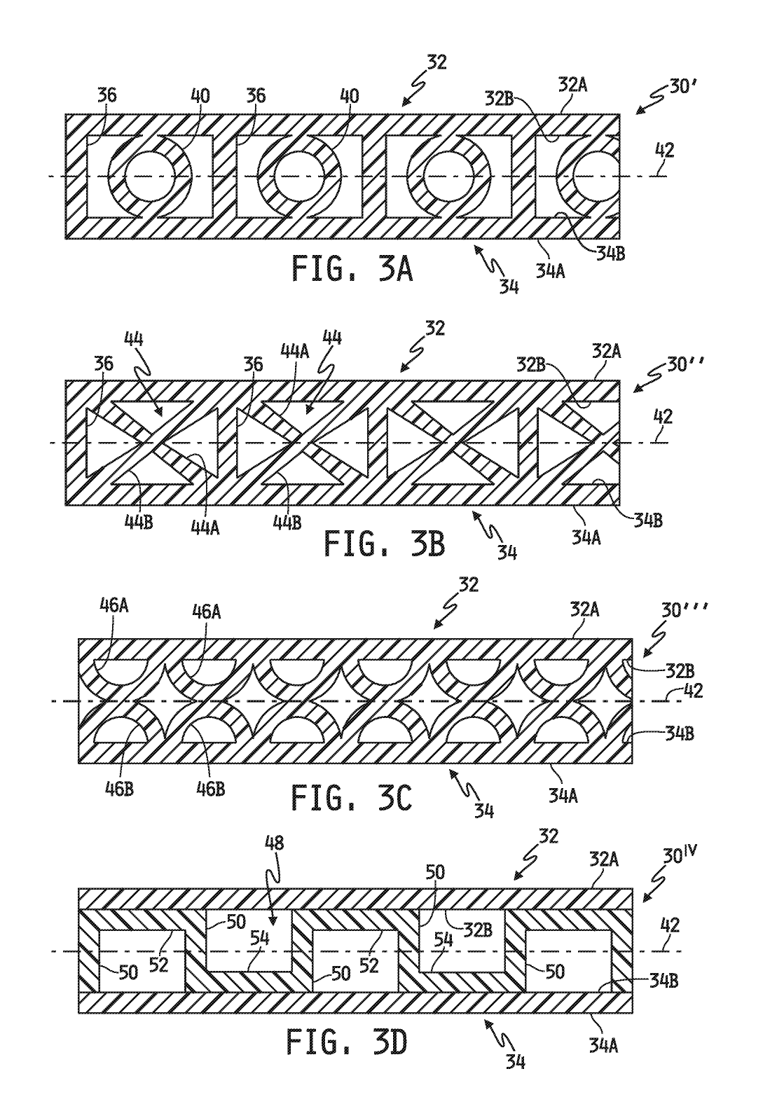

This disclosure is directed to apparatuses and methods for processing opposing-foil panels to produce single-foil ribbed sheets, and also to example products formed using one or more such single-foil ribbed sheets. Referring now to FIGS. 1A-1B, an embodiment is shown of an apparatus 10 for processing such opposing-foil panels to produce two single-foil ribbed sheets. In the embodiment illustrated in FIGS. 1A-1B, an example opposing-foil panel 30 is shown being processed into two single-foil ribbed sheets 38A, 38B, although it will be understood that the apparatus 10 is not limited to processing such panels 30 and that the apparatus 10 may alternatively or additionally process opposing-foil panels of alternate construction, some non-limiting examples of which are illustrated in FIGS. 3A-3F and will be described below.

In the embodiment illustrated in FIGS. 1A-1B, the apparatus 10 is illustratively provided in the form of a conventional skiver having a table 12 and a cutting tool 14 at or adjacent to one end of the table 12. The cutting tool 14 illustratively includes a blade 16 in the form of a belt or loop that is continuously rotationally driven by opposing drums 18A, 18B such that the portions of the blade 16 between the drums 18A, 18B are planar and substantially parallel with a planar top surface 12A of the table 12. In some embodiments, the tool 14 may include a sharpening device 20 in contact with the blade 16 to continuously sharpen a cutting edge 17 of the blade 16 that faces the table 12. In the embodiment shown in FIGS. 1A and 1B, the drums 18A, 18B illustratively rotate in a common direction 22 to thereby the blade 16 linearly in a direction 24 between the two drums 18A, 18B, wherein the upper linear portion 16A of the blade 16 between the drums 18A, 18B is used to cut objects as will be described below. It will be understood that in alternate embodiments, the blade 16 may be driven in the opposite direction and/or driven by one or more other conventional blade driving mechanism(s).

In one embodiment, the cutting tool 14 is stationary relative to the table 12, and the table 12 is configured or controlled to move toward the cutting tool 14 in a direction 26 normal to the plane defined by the linear portion 16A of the blade 16 between the two drums 18A, 18B. In some alternate embodiments, the table 12 may be stationary relative to the cutting tool 14, and the cutting tool 14 may be configured or controlled to move in a direction opposite to the direction 26 illustrated in FIGS. 1A and 1B, and in other alternate embodiments the table 12 and the cutting tool 14 may be configured to move toward each other along and opposite to the direction 26 respectively. In some embodiments, as illustrated in FIG. 1A (but omitted in FIG. 1B for clarity of illustration), the height of the linear portion 16A of the blade 16 relative to the top, planar surface 12A of the table 12 is illustratively adjustable and/or the depth of the top, planar surface 12A of the table 12 relative to the linear portion 16A of the blade 16 is adjustable via a conventional height adjustment mechanism 28 coupled to the drums 18A, 18B or to a housing or other structure supporting the drums 18A, 18B. In alternate embodiments, the height of the linear portion 16A of the blade 16 relative to the top, planar surface 12A of the table 12 may be fixed. In any case, the top surface 12A of the table 12 is configured to receive and support objects thereon, and the relative movement between the table 12 and cutting tool 14 advances the linear portion 16A of the blade 16 relative to the object such that the cutting edge 17 of the blade 16 cuts a planar path through the object.

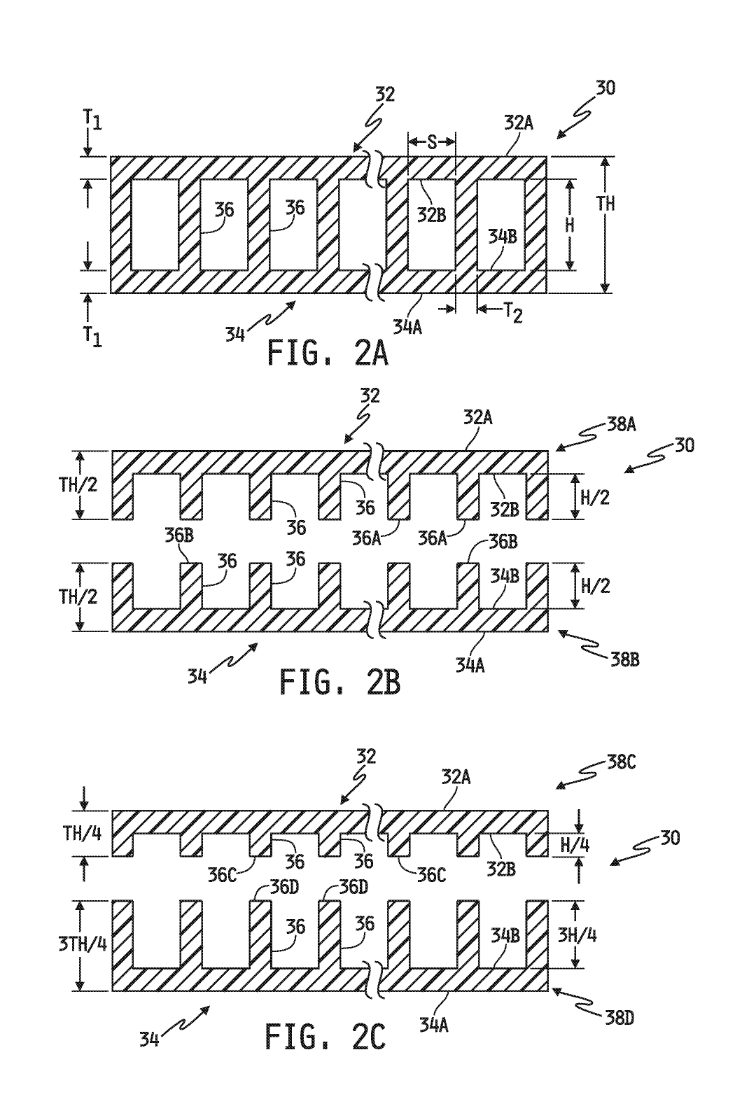

In the embodiment illustrated in FIGS. 1A-1B, the object processed by the apparatus 10 is an example embodiment of an opposing-foil panel 30. Referring now to FIGS. 1A, 1B and 2A, the illustrated embodiment of the opposing-foil panel 30 is an extruded panel having a length, L, between opposite ends 30A, 30B thereof and a width, W, between opposing sides 30C, 30D thereof. The panel 30 illustratively has opposing, i.e., spaced-apart, planar foils 32, 34 and a number of spaced-apart support structures 36 extending perpendicularly between and interconnecting inwardly facing surfaces 32B, 34B of the two opposing foils 32, 34 along their length L. The extruded panel 30 is of unitary construction with the panel foils 32, 34 and the interconnecting support structures 36 being integral structures. The panel 30 is illustratively extruded in the direction of its length, L, and this direction is typically referred to as the “machine direction.” The transverse direction, i.e., along its width, W, is typically referred to as the “cross-machine direction” or the trans-machine direction.” In some alternate embodiments, the panel 30 may be a laminated structure, and in some such embodiments in the support structures 36 may extend along and between the panel foils 32, 34 in the machine direction. In other alternate embodiments, the panel 30 may be a laminated structure, and the support structures 36 may extend along and between the panel foils 32, 34 in directions other than the machine direction.

The exposed, exterior surfaces 32A, 34A of the panel foils 32, 34 respectively each define major, planar, exterior surfaces of the panel 30 between the width W and the length L thereof, and each panel foil 32, 34 has a thickness T1 as illustrated in FIG. 2A. In the illustrated embodiment, the interconnecting support structures 36 are elongated, continuous and generally linear support walls, e.g., in the form of linear ribs or flutes, each extending in the machine direction between the inwardly facing surfaces 32B, 34B of the opposing foils 32, 34 along the length L of the panel 30. The interconnecting support walls 36 each have a height H defining the distance between the opposed, interior faces 32B, 34B of the panel foils 32, 34 respectively, such that the total height or thickness of the panel 30 is H+2T1=TH. The width or thickness of each support wall 36 is T2, and the spacing, S, between the support walls 36 is illustratively uniform along the width, W, of the panel 30. The dimensions of the foregoing features of the panel 30 are typically selected based on a number of considerations such as the desired performance characteristics of the panel 30, the weight of the finished panel 30, the cost of producing the panel 30 (including material cost), and/or the like. As one specific example, the total height or thickness TH of the panel 30 may typically range from 2 mm-5 mm, although it will be understood that panels 30 having total heights or thicknesses outside of this range are intended to fall within the scope of this disclosure.

Referring now to FIGS. 1A, 1B, 2A and 2B, the panel 30 is illustratively positioned on the table 12 with the outer planar surface 34A of the panel 30 resting on the planar surface 12A of the table 12 and with the end 30A of the panel 30 facing the cutting tool 14 such that the linear portion 16A of the blade extends along a blade plane that is parallel with planes defined by the planar foils 32, 34 and such that the edges of the outer planar surfaces 32A, 34A defining the end 30A of the panel 30 face the cutting edge 17 of the blade 16. In embodiments which include the height adjustment mechanism 28, the mechanism 28 is controlled in a conventional manner to set the desired horizontal position of the cutting edge 17 of the blade 16 relative to the total height or thickness TH of the panel 30. In any case, the table 12 and/or cutting tool 14 is/are moved in and/or against the direction 26 respectively to advance the linear portion 16A of the blade 16 through the panel 30 in the direction opposite of the direction 26 such that the cutting edge 17 of the blade 16 passes through the blade plane and severs each of the support walls 36 along the machine direction to thereby separate the foils 32, 34 along the blade plane that is parallel with the planar surfaces 32A, 32B and 34A, 34B of the planar foils 32, 34. The cutting edge 17 of the blade 16 is illustratively a continuous, sharp edge, e.g., a knife edge, which cuts through the support walls 36 without removing any material from the support walls 36, i.e., without leaving a kerf. In the illustrated embodiment, the linear portion 16A of the blade spans the width of the opposed-foil panel 30 such that the cutting edge 17 of the blade 16 severs each of the support members 36 along their length in a single pass of the blade 16 through the blade plane. In alternate embodiments, one or more other conventional cutting tools may be used in single or multiple passes thereof to sever the support members 36 and completely separate the opposed-foil panel 30 into two separate single-foil ribbed sheets.

By suitably adjusting the height of the linear portion 16A of the blade 16 relative to the top surface 12A of the table 12, the support walls 36 may be cut at any point along their height H to produce two single-foil ribbed sheets each having resulting support wall portions of desired height. In the example illustrated in FIG. 2B, the cutting edge 17 of the blade 16 is set to bisect the support walls 36. The resulting single-foil ribbed sheet 38A thus has support walls 36 of height H/2 between the cut ends 36A thereof and the inwardly facing surface 32B of the planar foil 32 and a total height of TH/2 between the outer surface 32A of the foil 32 and the cut ends 36A of the support walls 36, and the resulting single-foil ribbed sheet 38B likewise has support walls 36 of height H/2 between the cut ends 36B thereof and the inwardly facing surface 34B of the planar foil 34 and a total height of TH/2 between the outer surface 34A of the foil 34 and the cut ends 36B of the support walls 36. In the example illustrated in FIG. 2C, in contrast, the cutting edge 17 of the blade 16 is set closer to the inwardly facing surface 32B of the foil 32 such that the resulting single-foil ribbed sheet 38C has support walls 36 of height H/4 between the cut ends 36C thereof and the inwardly facing surface 32B of the planar foil 32 and the resulting single-foil ribbed sheet 38D has support walls 36 of height 3H/4 between the cut ends 36D thereof and the inwardly facing surface 34B of the planar foil 34. Those skilled in the art will appreciate that the height of the linear portion 16A of the blade 16 relative to the top surface 12A of the table 12 may be set to achieve any desired length(s) or ratios of the support walls on the resulting single-foil ribbed sheets, or to achieve one resulting single-foil ribbed sheet having support walls of or near H and another resulting single foil having little or no remaining support walls extending therefrom.

It will be appreciated that the use of a moving cutting blade, such as the cutting blade 16 illustrated and described above, avoids material loss since such a blade cuts through and separates the support walls 36 from each other without removing material as would otherwise occur when using conventional abrasive cutting instruments such as a saw or grinder. In the illustrated embodiment, for example, as the cutting tool 14 drives the cutting edge 17 of the blade 16 in the cross-machine direction and the and the table 12 and/or the cutting tool 14 are advanced toward each other along the machine direction 26, the cutting edge 17 of the blade 16 cuts through the support walls 36 without removing any material from the support walls 36, i.e., without leaving a kerf. When using a skiver 10 or other driven cutting blade, it is desirable to orient the blade and/or the opposing-foil panel such that the blade cuts through the interconnecting support structures along the machine direction so as to maintain substantially constant pressure on and along the blade during the cutting process, although it will be understood that alternate orientations of the blade and/or the opposing-foil panel are intended to fall within the scope of this disclosure.

The processes and techniques described herein are not limited to the use of moving cutting blades or to the use of conventional skivers as described above. Rather, any suitable machine-driven or manually actuated tool(s) for cutting, grinding, sawing or the like may be alternatively used to separate opposing-foil panels into single-foil ribbed sheets as illustrated and described herein, and it will be understood that an such other tool(s) is/are intended to fall within the scope of this disclosure.

Separation of opposing-foil panels into single-foil ribbed sheets as described herein is not limited to separation of opposing-foil panels having interconnecting support structures in the form of spaced-apart ribs or flutes extending longitudinally along the machine direction, such as the support walls 36 of the opposing-foil panels 30 illustrated in FIGS. 1A-2C. Rather, it will be understood that the panels 30 having ribbed or fluted interconnecting support walls 36 represent only one non-limiting example embodiment of such opposing-foil panels, and that this disclosure contemplates embodiments in which opposing-foil panels having myriad other forms of interconnecting support structures are separated as described above. As one example, FIG. 3A shows a first alternative embodiment of an opposing-foil panel 30′ having opposing foils 32, 34 interconnected by a number of spaced-apart support structures in the form of ribs or flutes 36 extending perpendicularly between and interconnecting inwardly facing surfaces 32B, 34B of the two opposing foils 32, 34 along their length L as described above with respect to the opposing-foil panel 30. Additionally, the opposing foils 32, 34 are interconnected by a number of cylindrical support structures 40, each disposed in a space between two adjacent ribs or flutes 36. In the illustrated embodiment, the cylindrical support structures 40 are elongated structures each extending in the machine direction between the inwardly facing surfaces 32B, 34B of the opposing foils 32, 34 along the length of the panel 30′. The example panel 30′ is illustratively an extruded panel and is therefore of unitary construction with the panel foils 32, 34 and the interconnecting support structures 36, 40 being integral structures. In some alternate embodiments, the panel 30′ may be a laminated structure, and/or the ribs or flutes 36 and the cylindrical support structures 40 may extend in directions other than the machine direction. In other alternate embodiments, whether of unitary or laminated construction, one or more of the interconnecting support structures 36 may be omitted from the panel 30′, and the cylindrical support structures 40 may be suitable spaced apart along the cross-machine direction of the panel 30′. In any case, the dashed line 42 illustratively represents a plane through which the blade 16 of the cutting tool 14 may pass to bisect the panel 30′ into two single-foil sheets as described above with respect to FIG. 2B.

FIG. 3B shows a second alternative embodiment of an opposing-foil panel 30″ having opposing foils 32, 34 interconnected by a number of spaced-apart support structures in the form of ribs or flutes 36 extending perpendicularly between and interconnecting inwardly facing surfaces 32B, 34B of the two opposing foils 32, 34 along their length L as described above with respect to the opposing-foil panel 30. Additionally, the opposing foils 32, 34 are interconnected by a number of X-shaped support structures 44, each disposed in a space between two adjacent ribs or flutes 36. In the illustrated embodiment, the X-shaped support structures 44 are elongated structures having a first leg 44A extending in the machine direction and along a first diagonal between the inwardly facing surfaces 32B, 34B of the opposing foils 32, 34 along the length of the panel 30″, and a second leg 44B also extending in the machine direction and along a second diagonal, crossing the first diagonal, between the inwardly facing surfaces 32B, 34B of the opposing foils 32, 34 along the length of the panel 30″. The example panel 30″ is illustratively an extruded panel and is therefore of unitary construction with the panel foils 32, 34 and the interconnecting support structures 36, 44 being integral structures. In some alternate embodiments, the panel 30″ may be a laminated structure, and/or the ribs or flutes 36 and the X-shaped support structures 44 may extend in directions other than the machine direction. In other alternate embodiments, whether of unitary or laminated construction, one or more of the interconnecting support structures 36 may be omitted from the panel 30″, and the cylindrical support structures 44 may be suitable spaced apart along the cross-machine direction of the panel 30″. In any case, the dashed line 42 illustratively represents a plane through which the blade 16 of the cutting tool 14 may pass to bisect the panel 30″ into two single-foil sheets as described above with respect to FIG. 2B.

FIG. 3C shows a third alternative embodiment of an opposing-foil panel 30′″ having opposing foils 32, 34 interconnected by a number of spaced-apart support structures in the form of back-to-back, arcuate structures 46A, 46B extending between and interconnecting the inwardly facing surfaces 32B, 34B of the two opposing foils 32, 34 along their length L. In the illustrated embodiment, the arcuate support structures 46A are elongated structures each having a pair of legs extending toward each other in an arc from the inwardly facing surface 32B of the foil 32 along the cross-machine direction with the zenith of the arcuate structure 46A facing away from the inwardly facing surface 32B. The arcuate support structures 46B are likewise elongated structures each having a pair of legs extending toward each other in an arc from the inwardly facing surface 34B of the foil 34 along the cross-machine direction with the zenith of the arcuate structure 46B facing away from the inwardly facing surface 34B. The zeniths of the arcuate structures 46A are aligned with the zeniths of corresponding ones of the arcuate structures 46B. The example panel 30′″ is illustratively an extruded panel and is therefore of unitary construction with the panel foils 32, 34 and the interconnecting arcuate support structures 46A, 46B being integral structures such that the zeniths of arcuate structures 46A merge with the zeniths of aligned ones of the arcuate structures 46B. In some alternate embodiments, the panel 30′″ may be a laminated structure, and/or the interconnecting arcuate support structures 46A, 46B may extend in directions other than the machine direction. In other alternate embodiments, whether of unitary or laminated construction, interconnecting support structures 36, as described above, may be interposed between every Nth set of arcuate structures 46A, 46B, wherein N may be any positive integer. In any case, the dashed line 42 illustratively represents a plane through which the blade 16 of the cutting tool 14 may pass to bisect the panel 30′″ into two single-foil sheets as described above with respect to FIG. 2B.

FIG. 3D shows a fourth alternative embodiment of an opposing-foil panel 30^{IV} having opposing foils 32, 34 interconnected by an inner foil 48 in the form of a serpentine or corrugated structure extending between and interconnecting the inwardly facing surfaces 32B, 34B of the two opposing foils 32, 34 along their length L. In the illustrated embodiment, the inner foil 48 includes planar or partially planar sections 52 affixed to the inwardly facing surface 32B of the foil 32 and planar or partially planar sections 54 affixed to the inwardly facing surface 34B of the foil 34, wherein the planar or partially planar sections 52, 54 alternate along the cross-machine direction and are interconnected at their edges by interconnecting sections 50. In the illustrated embodiment, the interconnecting sections 50 are orientated perpendicularly to the planes defined by the inwardly facing surfaces 32B, 34B, although in other embodiments the interconnecting sections 50 may be oriented diagonally or with some other shape. The example panel 30^{IV} is illustratively a laminated panel with the inner foil 48 affixed to the inwardly facing surfaces 32B, 34B of the foils 32, 34 respectively in a conventional manner, e.g., via heat bonding, adhesive attachment or the like. In some alternate embodiments, the panel 30^{IV} may be an extruded panel of unitary construction with the panel foils 32, 34 and the inner foil 48 being integral structures. In any case, the serpentine or corrugated structure of the inner foil 48 may extend in directions other than the machine direction. In the embodiment shown in FIG. 3D, the dashed line 42 illustratively represents a plane through which the blade 16 of the cutting tool 14 may pass to bisect the panel 30^{IV} into two single-foil sheets as described above with respect to FIG. 2B.

FIG. 3E shows a fifth alternative embodiment of an opposing-foil panel 30^{V} having opposing foils 32, 34 interconnected by an inner foil 56 in the form of an alternating cup structure extending between and interconnecting the inwardly facing surfaces 32B, 34B of the two opposing foils 32, 34 along their length L. In the illustrated embodiment, the inner foil 56 includes a plurality of cups 58 each having a planar or partially planar section 58A affixed to the inwardly facing surface 32B of the foil 32 and another plurality of cups 60 each having a planar or partially planar section 60A affixed to the inwardly facing surface 34B of the foil 34. Wall sections of the cups 58 and 60 are interconnected by planar or partially planar sections 62 extending between the wall sections of the cups 58, 60, and the cups 58, 60 illustratively alternate in a diagonal direction relative to the machine direction. In the illustrated embodiment, the interconnecting sections 62 are orientated parallel to the planes defined by the inwardly facing surfaces 32B, 34B, although in other embodiments the interconnecting sections 62 may be oriented diagonally or with some other shape. The example panel 30^{V} is illustratively a laminated panel with the inner foil 56 affixed to the inwardly facing surfaces 32B, 34B of the foils 32, 34 respectively in a conventional manner, e.g., via heat bonding, adhesive attachment or the like. In some alternate embodiments, the panel 30^{V} may be an extruded panel of unitary construction with the panel foils 32, 34 and the inner foil 56 being integral structures. In any case, the cups 58, 60 of the inner foil 56 may extend in directions other than diagonal to the machine direction. In the embodiment shown in FIG. 3E, the dashed line 42 illustratively represents a plane through which the blade 16 of the cutting tool 14 may pass to bisect the panel 30^{V} into two single-foil sheets as described above with respect to FIG. 2B.

It will be understood that the various panel embodiments 30-30^{V} illustrated in FIGS. 2A-3E are provided only by way of example, and should not be considered to be limiting in any way. Those skilled in the art will recognize other linear, piece-wise linear, non-linear or a combination of linear/piece-wise linear and non-linear structures that may be interconnected in any combination between the opposed, inwardly facing surfaces 32B, 34B of the panel foils 32, 34 to form a unitary or laminated structure, and it will be understood that any such structures and resulting panel embodiments are intended to fall within the scope of this disclosure. In embodiments in which opposing-foil panels are of unitary construction, e.g., any of panels 30-30^{III}, such panels are illustratively provided in the form of polymer structures fabricated in accordance with one or more conventional extrusion processes. In some such embodiments, the polymer may be a thermoplastic polyolefin, examples of which may be or include, but are not limited to, polypropylene, polyethylene, polymethylpentene, and/or polybutene-1. In embodiments in which opposing-foil panels are laminated structures, e.g., either of panels 30^{IV}, 30^{V}, such panels are likewise illustratively provided in the form of laminated polymer structures. It will be understood, however, that opposing-foil panels, whether of unitary construction or laminated, are not limited to polymers, and in alternate embodiments opposing-foil panels may be formed, in whole or in part, from one or more non-polymer materials, and/or may be formed using one or more processes other than, or in addition to, a conventional extrusion process and/or a conventional lamination process, and it will be understood that any such alternate panel stock material(s) and/or formation process(es) is/are intended to fall within the scope of this disclosure.

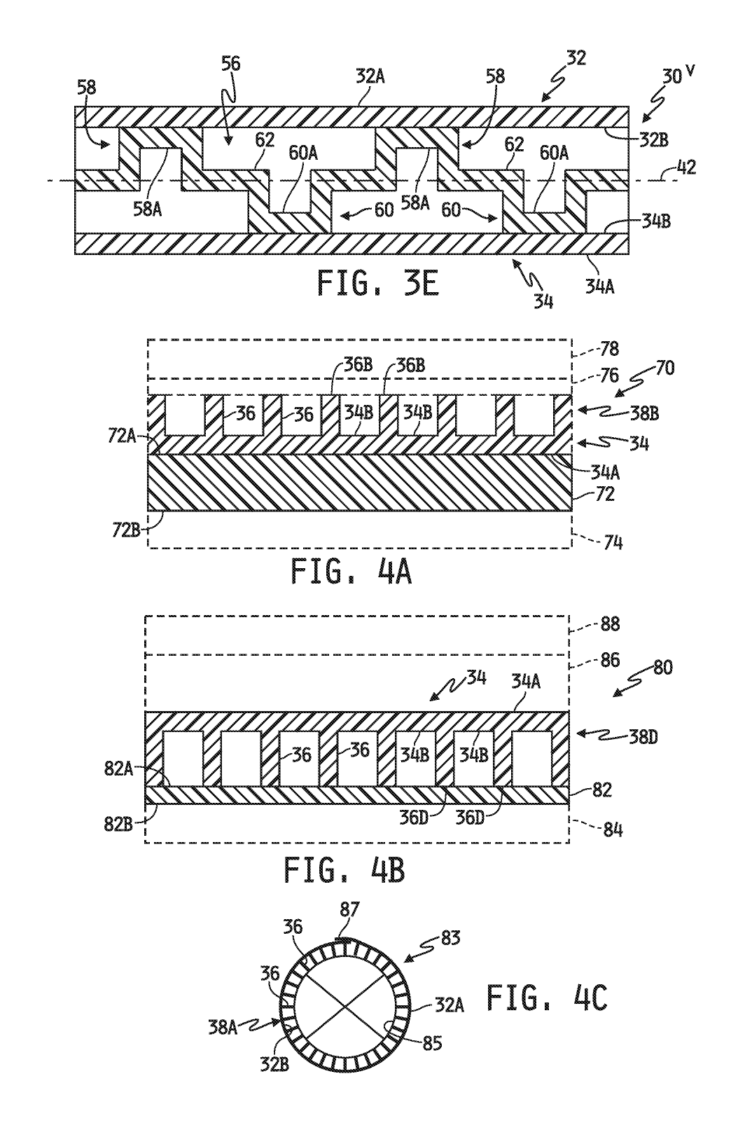

Single-foil ribbed sheets of the type produced by separating opposing-foil panels as described above have a number of physical properties, characteristics and/or attributes which suit them to implementation in a wide range of products. Referring now to FIG. 4A, a first example product is shown in the form of a fluid guiding device 70. In the illustrated embodiment, the device 70 includes one of the single-foil ribbed sheets, e.g., the single foil ribbed sheet 38B of FIG. 2B, positioned with the exterior surface 34A of the foil 34 facing downwardly such that the opposite surface 34B of the foil 34, and thus the support walls 36, face upwardly. So oriented, the upstanding support walls 36 are operable to guide liquid through channels defined therebetween, and the device 70 may illustratively be implemented in this capacity as a drainboard, a floor mat for automotive, home or business use, roofing material, or other liquid guiding device or apparatus for directing liquid flow along a structural surface 74 through the channels. In some embodiments, a substrate 72 may be affixed or attached to the exterior surface 34A of the foil 34, as illustrated in FIG. 4A, e.g., for rigidity or support. In still other embodiments, the substrate 72 (or the surface 34A of the foil 34) may be affixed or attached to the structural support surface 74. In any of the above and/or further embodiments, the upwardly facing cut surfaces 36B of the upstanding support walls 36 may be affixed or attached to a substrate 76, and in such embodiments the utility of the device 70 is not limited to guiding the flow of liquids but may also be operable to guide fluid flow generally. In still other embodiments, the substrate 76 (or the cut surfaces 36B of the upstanding support walls 36) may be affixed or attached to a stationary support surface 78.

Referring now to FIG. 4B, a second example product is shown in the form of another fluid guiding device 80. In the illustrated embodiment, the device 80 includes one of the single-foil ribbed sheets, e.g., the single foil ribbed sheet 38D of FIG. 2C, positioned with the exterior surface 34A of the foil 34 facing upwardly such that the opposite surface 34B of the foil 34, and thus the support walls 36, face downwardly. So oriented, the downwardly extending support walls 36 are operable to guide fluid flow through channels defined therebetween while the solid foil 34 is operable to confine the fluid below the surface 34B thereof. Such a device 80 may illustratively be implemented in this capacity as a fluid cooling device for confining and directing a liquid or other fluid through the channels defined between the support walls 36 to cool a structure or structural surface 84 located below the terminal faces 36D of the support walls 36. Alternatively or additionally, the device 80 may be implemented in the form of a ventilation device in which the foil 34 confines ventilating fluid below the surface 34B thereof and the support walls 36 operate to guide the flow of ventilating fluid along the channels defined therebetween. Such a ventilation device may be implemented, for example, as a ridge vent in residential and/or commercial roofing applications, as a moisture directing/drying and/or ventilation layer in residential or commercial flooring and/or sub-flooring applications, or the like.

In the embodiment illustrated in FIG. 4B, the cut surfaces 36D of the support walls 36 are in contact with a substrate 82. In some embodiments, the substrate 82 may represent a single sheet or layer to which the cut surfaces 36D are affixed, attached, mounted or otherwise coupled. In other embodiments, the substrate 82 may represent a sheet or layer of a multi-layer structure to which the cut surfaces 36D of the support walls 36 are affixed, attached, mounted or otherwise coupled. In still other embodiments, the substrate 82 may represent a surface of a structure which the cut surfaces 36D of the support walls 36 abut but to which the cut surfaces 36D are not affixed, attached, mounted or otherwise coupled. In further embodiments, the substrate 82 (or the cut surfaces 36D of the support structures 36) may be affixed or attached to, or abut, the structural support surface 84. In any of the foregoing and/or further embodiments, the surface 34A of the foil 34 may be affixed or attached to a substrate 86. In some such embodiments, the substrate 86 (or the surface 34A of the foil 34) may be affixed or attached to a stationary support surface 88.

Referring now to FIG. 4C, a third example product is shown in the form of a flexible packing mat 83 that may be wrapped about an exterior surface of an object, or a portion thereof, to protect the object during shipping and/or storage. In the illustrated embodiment, the object is a cylinder 85, e.g., an electrical coil, glassware, etc., although it will be understood that the object, or portion thereof, about which the flexible packing mat 83 may be wrapped is not limited to cylindrical objects and may be used with objects of other external shapes or profiles. In the example illustrated in FIG. 4C, the flexible packing mat 83 is provided in the form of one of the single-foil ribbed sheets, e.g., the single foil ribbed sheet 38A of FIG. 2B, wrapped about the object 85 and oriented such that the free or cut ends 36A of the support walls 36 are in contact with the exterior surface of the object 85 about its outer periphery so that the flexible foil 32 is spaced apart from the outer surface of the cylindrical object 85 by the support walls 36. Opposing sides of the mat 83 are illustratively overlapped, and optionally affixed or otherwise joined to each other in a conventional manner, e.g., to form a seam 87. The single-foil ribbed sheet 38A provides for a light weight, flexible packing mat 83 with inherent cushioning provided by the support walls 36 separating the exterior surface of the cylinder 85 from the protective foil 32 for protection of the exterior surface of the object 85 from contact by other objects.

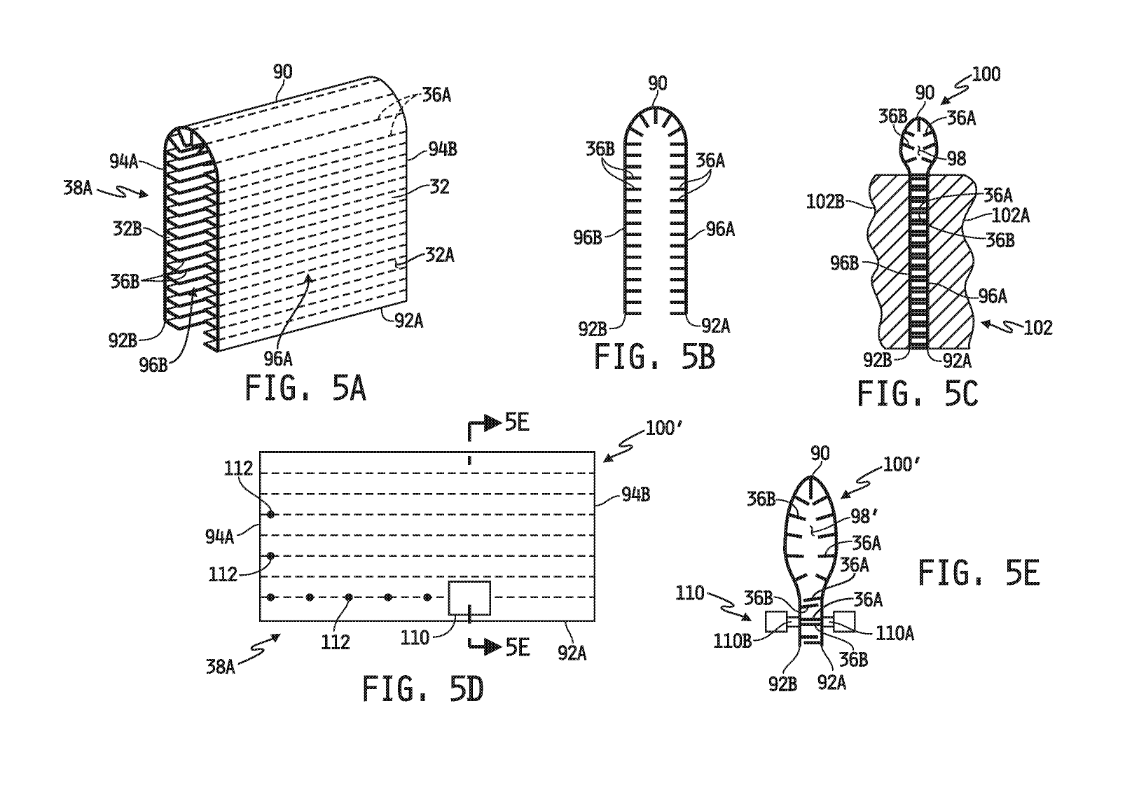

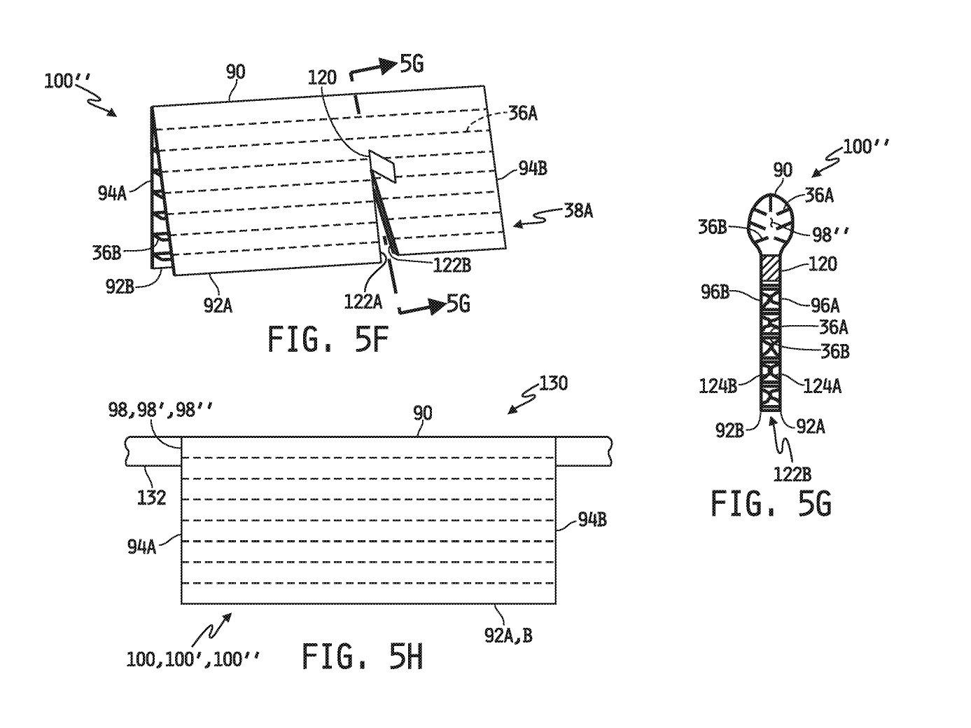

Referring now to FIGS. 5A-5H, a third example product is shown in the form of a supportable divider that may be used on its own or as part of an array or matrix of such supportable dividers for separating objects, e.g., during shipping and/or storage. Referring specifically to FIGS. 5A and 5B, an embodiment of a supportable divider is shown which begins with a single-foil ribbed sheet, e.g., the single foil ribbed sheet 38A of FIG. 2B, folded along a fold line 90 that is parallel with the longitudinal direction of the elongated support structures 36, i.e., folded along the machine direction of the sheet 38A. The resulting folded sheet has a sheet section or flap 96A defined between the fold 90, one free end 92A and opposite sides 94A, 94B of the sheet 38A, and another opposing sheet section or flap 96B defined between the fold 90, an opposite free end 92B and the opposite sides 94A, 94B. The opposing sheet sections or flaps 96A, 96B are illustratively bonded, affixed or otherwise attached to each other in a manner that defines an opening through and between the opposed flaps 96A, 96B adjacent to the fold 90 which is bounded by one or more bonded portions of the flaps 96A, 96B and the inner surface 32B of the sheet 38A defining the opening. The resulting folded and bonded sheet 38A forms a supportable divider, and the opening defined therethrough is illustratively sized to receive therein an elongated support member, e.g., a bar, rod or bracket, suitable for supporting the supportable divider between spaced-apart support structures.

Referring to FIG. 5C, one example supportable divider 100 is shown which is formed by bonding together the opposing flaps 96A, 96B using a conventional heating unit 102. In the illustrated embodiment, the heating unit 102 illustratively includes two opposed linear or planar sides 102A, 102B, either or both of which may be heated in a conventional manner. The opposed flaps 96A, 96B are illustratively drawn together such that the support structures 36A extending from the inner surface 32B of the flap 96A interdigitate with the support structures 36B extending from the inner surface 32B of the opposing flap 96B as illustrated in FIG. 5C. As the two opposing sides 102A, 102B of the heating unit 102 are brought together with the drawn-together flaps 96A, 96B positioned therebetween, heat from the heating unit 102 illustratively causes the foil 32, the support structures 36A extending from the inner surface 32B of the flap 96A and the support structures 36B extending from the inner surface 32B of the flap 96B to at least partially melt or otherwise be raised to a sufficiently high temperature such that the free ends of the support structures 36A thermally bond to the inner surface 32B of the flap 96B and the support structures 36B thermally bond to the inner surface 32B of the flap 96A. In some alternate embodiments, the temperature of the heating unit 102 may be controlled to melt the support structures 36A, 36B such that the opposed inner surfaces 32B of the flaps 96A, 96B bond together via the melted support structures 36A, 36B as the opposing sides 102A, 102B of the heating unit 102 are forced together. In any of the foregoing embodiments, the temperature of the heating unit 102 may be controlled to at least partially melt the opposed inner surfaces 32B of the flaps 96A, 96B or one or more portions thereof so that such inner surfaces 32B or one more portions thereof bond together as the opposing sides 102A, 102B of the heating unit 102 are forced together.

In one embodiment, the sides 102A, 102B of the heating unit 102 are planar and extend across the widths of the flaps 96A, 96B from the sides 94A to the sides 94B, and extend upwardly from the ends 92A, 92B toward the fold 90, leaving a section near the fold 90 in which the flaps 92A, 92B are not bonded to each other, thereby forming an opening 98 through the folded and bonded flaps 96A, 96B. The opening 98 illustratively extends between and through the flaps 96A, 96B and is bounded by the inner surface 32B of the sheet 38A and the bonded portion thereof. In some alternate embodiments, the sides 102A, 102B of the heating unit 102 may be planar but define a planar area therebetween that is less than the width of the flaps 96A, 96B and/or less than a height defined between the ends 92A, 92B of the flaps 96A, 96B and the opening 98. In such embodiments, the flaps 96A, 96B may be bonded together at one or more locations.

In other alternate embodiments, the sides 102A, 102B of the heating unit 102 may be linear and extend in a direction parallel with the ends 92A, 92B of the flaps 96A, 96B. In some such embodiments, the lengths linear sides 102A, 102B of the heating unit 102 may extend from one side 94A of the flaps 96A, 96B to the other, and in other embodiments the lengths of the linear sides 102A, 102B may be less than the width of the flaps 96A, 96B between the sides 94A, 94B. In any case, the heating unit 102 may be operated in a conventional manner to form any number of linear thermal bonds between the sides 94A, 94B of the flaps 96A, 96B and/or between the ends 92A, 92B of the flaps 96A, 96B and the opening 98. In still other alternate embodiments, the sides 102A, 102B of the heating unit 102 may be linear and extend in a direction parallel with the sides 94A, 94B of the flaps 96A, 96B. In some such embodiments, the lengths linear sides 102A, 102B of the heating unit 102 may extend from the ends 92A, 92B of the flaps 96A, 96B to the opening 98, and in other embodiments the lengths of the linear sides 102A, 102B may be less than the height between the ends 92A, 92B of the flaps 96A, 96B and the opening 98. In any case, the heating unit 102 may be operated in a conventional manner to form any number of linear thermal bonds between the ends 92A, 92B and the opening 98 and/or between the sides 94A, 94B of the flaps 96A, 96B. In still further alternate embodiments, the sides 102A, 102B of the heating unit 102 may be non-linear or piecewise linear, and the heating unit 102 may be operated in a conventional manner to form any number of non-linear or piecewise linear thermal bonds between the ends 92A, 92B and the opening 98 and/or between the sides 94A, 94B of the flaps 96A, 96B.

Referring now to FIGS. 5D and 5E, another example supportable divider 100′ is shown which is formed by bonding together the opposing flaps 96A, 96B of a single-foil ribbed sheet, e.g., sheet 38A, at a number of different discrete points using a conventional heating unit 110. In the illustrated embodiment, the heating unit 110 illustratively includes two opposed probes or tips 110A, 110B, either or both of which may be heated in a conventional manner. The opposed flaps 96A, 96B are illustratively drawn together such that the support structures 36A extending from the inner surface 32B of the flap 96A interdigitate with the support structures 36B extending from the inner surface 32B of the opposing flap 96B as described above. As the two opposing tips 110A, 110B of the heating unit 110 are brought together with the drawn-together flaps 96A, 96B positioned therebetween, heat from the heating unit 110 illustratively causes the corresponding opposing portions of the inner surface 32B of the foil 32 and/or support structure(s) 36A and/or 36B trapped therebetween to at least partially melt or otherwise be raised to a sufficiently high temperature to thermally bond to each other. The heating unit 110 may be used to form any number of such “point bonds” between corresponding opposed portions of the flaps 96A, 96B and an example unfinished pattern of several such point bonds is illustrated in FIG. 5D. It will be understood that one or more such point bonds may be formed using the heating unit 110 to form a resulting supportable divider 100′ with a section near the fold 90 in which the flaps 92A, 92B are not bonded to each other, thereby forming an opening 98′ through the folded and bonded flaps 96A, 96B. The opening 98′ illustratively extends between and through the flaps 96A, 96B and is bounded by the inner surface 32B of the sheet 38A and at least part of the bonded portion thereof.

Referring now to FIGS. 5F and 5G, yet another example supportable divider 100″ is shown which is formed by bonding together the opposing flaps 96A, 96B of a single-foil ribbed sheet, e.g., sheet 38A, at and at least partially long one or more of the ends 92A, 92B and sides 94A, 92B thereof using a conventional cutting tool which generates sufficient heat during the process of cutting the combination of the opposing flaps 96A, 96B to thermally bond the opposing flaps 96A, 96B together at and/or near the location(s) of the cut(s). In the illustrated embodiment, a conventional saw blade 120 is used to cut the supportable divider 100″ from the sheet 38A, and combination of the moving saw blade 120 in contact with the sheet 38A illustratively generates sufficient heat to bond together the flaps 96A, 96B along the cut edges 122A, 122B as illustrated in FIG. 5F. The opposed flaps 96A, 96B are illustratively drawn together such that the support structures 36A extending from the inner surface 32B of the flap 96A interdigitate with the support structures 36B extending from the inner surface 32B of the opposing flap 96B as described above and as shown in FIG. 5G. As the saw blade 120 cuts through the opposing flaps 96A, 96B to form two opposing cut edges 122A, 122B, heat generated by the cutting action of the saw blade 120 illustratively causes the corresponding opposing portions of the inner surface 32B of the foil 32 and the support structure(s) 36A and/or 36B to at least partially melt or otherwise be raised to a sufficiently high temperature to thermally bond to each other along the cut edges 122A, 122B. In some embodiments, such heat generated by the cutting action of the saw blade 120 may alternatively or additionally cause portions 124A, 124B of the foil 32 along the edges 122A, 122B to overlap and thermally bond together as illustrated in FIG. 5G. It will be understood that heat generated by the cutting action of such a saw blade 120 may be used to form such edge bonds at least partially along the ends 92A, 92B and/or at least partially along either or both of the sides 94A, 94B of the sheet 38A to form a resulting supportable divider 100″ with a section near the fold 90 in which the flaps 92A, 92B are not bonded to each other, thereby forming an opening 98″ through the folded and bonded flaps 96A, 96B. The opening 98″ illustratively extends between and through the flaps 96A, 96B and is bounded by the inner surface 32B of the sheet 38A and at least part of the bonded portion thereof. In embodiments in which both sides 94A, 94B are thermally bonded together using the saw blade 120, the opening 98″ may be formed by stopping the saw blade 120 at the boundary of the opening 98″ and cutting the remainder of the sides 94A, 94B using a cutting tool, e.g., a knife, so as not to bond the sides 94A, 94B over the opening. Alternatively, the opening 98″ may be formed by separating the flaps 96A, 96B at the sides 94A, 94B near the fold 90 to form the opening 98″. Those skilled in the art will recognize other cutting tools that may be used in place of the saw blade 120 which generate sufficient heat during cutting to thermally bond the flaps 96A, 96B together as just described, and it will be understood that any such other cutting tool(s) are intended to fall within the scope of this disclosure.

Referring now to FIG. 5H, a supported divider 130 is shown in which the supportable divider 100, 100′, 100″ is illustratively supported by an elongated support member 132, e.g., in the form of a rod, bar or bracket, passing through the opening 98, 98′, 98″. The rod, bar or bracket 132 is illustratively supported at either end thereof, or at or near either side of the divider 100, 100′, 100″, such that the supportable divider 100, 100′, 100″ is suspended by the rod, bar or bracket 132.

FIGS. 5C-5G illustrate a number of different devices and techniques for thermally bonding one or more support structures 36A to an opposing inner surface 32B of a flap 96B of a folded single-foil ribbed sheet, e.g., sheet 38A, thermally bonding one or more support structures 36B to an opposing inner surface 32B of a flap 96A of the folded single-foil sheet, and/or thermally bonding together one or more portions of opposing inner surfaces 32B of the single-foil ribbed sheet. Those skilled in the art will recognize alternate devices, apparatuses and/or techniques for accomplishing any such thermal bonding, and it will be understood that any such alternate devices, apparatuses and/or techniques are intended to fall within the scope of this disclosure. It will be further understood that any such thermal bonding devices, apparatuses and/or techniques may be supplemented or supplanted by one or more conventional attachment media, devices and/or techniques, examples of which may include, but are not limited to, one or more curable or non-curing bonding media, one or more adhesives or adhesive layers, one or more adhesive-backed tapes, one or more hook-and-loop combinations, one or more conventional mechanical attachment structures, or the like.

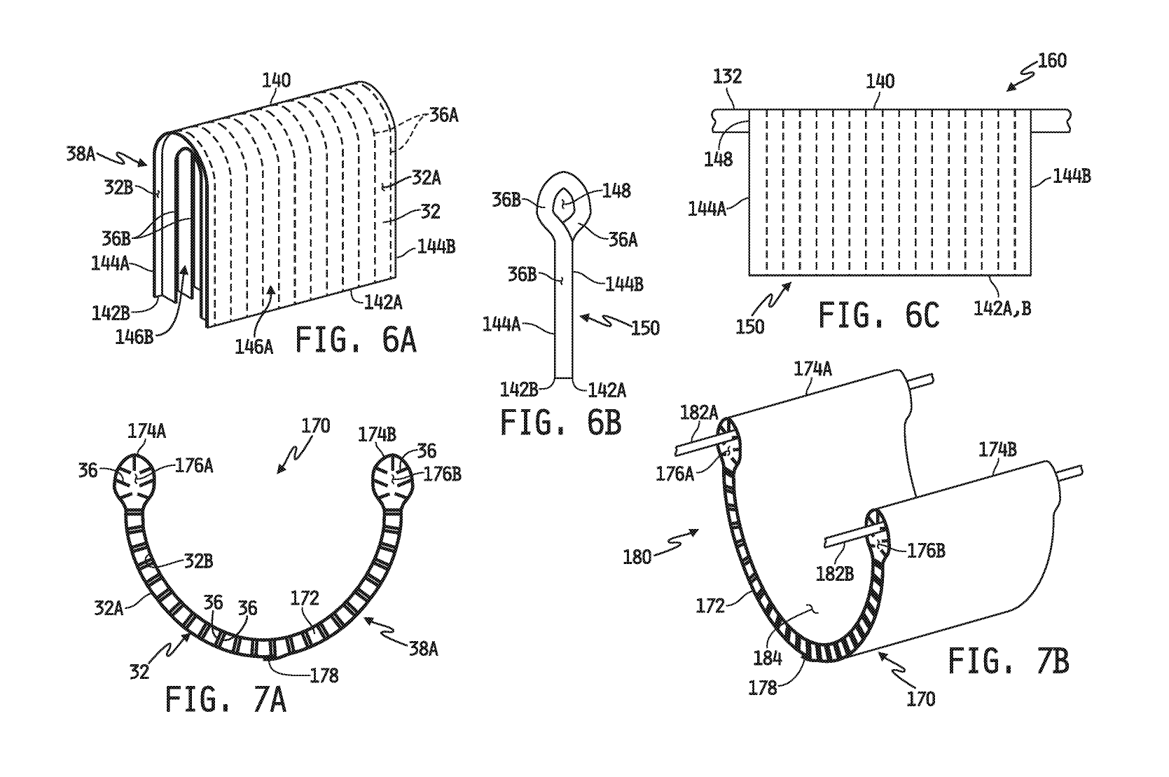

Referring now to FIGS. 6A and 6B, a fourth example product is shown in the form of another supportable divider 150 that may be used on its own or as part of an array or matrix of such supportable dividers for separating objects, e.g., during shipping and/or storage. Referring specifically to FIG. 6A, the example a supportable divider 150 illustratively begins with a single-foil ribbed sheet, e.g., the single foil ribbed sheet 38A of FIG. 2B, folded along a fold line 140 that is perpendicular to the longitudinal direction of the elongated support structures 36, i.e., folded along the cross-machine direction of the sheet 38A. The resulting folded sheet has a sheet section or flap 146A defined between the fold 140, one free end 142A and opposite sides 144A, 144B of the sheet 38A, and another opposing sheet section or flap 146B defined between the fold 140, an opposite free end 142B and the opposite sides 144A, 144B. The opposing sheet sections or flaps 146A, 146B are illustratively bonded, affixed or otherwise attached to each other in any manner described above with respect to FIGS. 5A-5H so as to define an opening 148 through and between the opposed flaps 146A, 146B adjacent to the fold 140 which is bounded by one or more bonded portions of the flaps 146A, 146B and the inner surface 32B of the sheet 38A defining the opening 140. The resulting folded and bonded sheet 38A forms a supportable divider 150, and the opening 148 defined therethrough is illustratively sized to receive therein an elongated support member, e.g., a bar, rod or bracket, suitable for supporting the supportable divider 150 between spaced-apart support structures. Referring specifically to FIG. 6B, a supported divider 160 is shown in which the supportable divider 150 is illustratively supported by a rod, bar or bracket 132 passing through the opening 148. The rod, bar or bracket 132 is illustratively supported at either end thereof such that the supportable divider 150 is suspended by the rod, bar or bracket 132.

Referring now to FIGS. 7A and 7B, a fifth example product is shown in the form of an object storage and/or transport sleeve or pocket 170 that may be used on its own or as part of an array or matrix of such pockets for supporting, separating and/or protecting objects, e.g., during storage and/or shipping. The illustrated embodiment begins with an elongated, single-foil ribbed sheet, e.g., the single-foil ribbed sheet 38A of FIG. 2B, folded along a pair of parallel fold lines 174A, 174B to define an elongated section 172 between the folds 174A, 174B in and along which the support structures 36 are interdigitated with each other as described above, and openings 176A, 176B at either end of the pocket 170 adjacent to the fold lines 174A, 174B respectively. The interior surfaces 32B of the flexible planar foil 32 face each other between the fold lines 174A, 174B, and the single-foil ribbed sheet 38A is thermally bonded together at one or more locations between the fold lines 174A, 174B leaving an opening 176A adjacent to and along the fold line 174A which extends completely through the folded, single-foil ribbed sheet 38A and another opening 176B adjacent to and along the fold line 174B which extends completely through the folded, single-foil ribbed sheet 38A.

In the illustrated embodiment, the fold lines 174A, 174B are illustratively parallel with the longitudinal direction of the elongated support structures 36, i.e., parallel with the machine direction of the sheet 38A as illustrated in FIG. 5A, although in other embodiments the fold lines 174A, 17B may be perpendicular to the longitudinal direction of the elongated support structures 36, e.g., as illustrated in FIG. 6A, such that the fold lines 174A, 174B are parallel with the cross-machine direction of the sheet 38A. The sheet 38A is illustratively bonded to itself along the elongated section 172, e.g., using any one or more of the thermal bonding or other attachment techniques described hereinabove. Opposing ends of the sheet 38A are illustratively overlapped, and optionally joined together in a conventional manner, to form a seam 178.

Referring specifically to FIG. 7B, a supported pocket or sleeve 180 is shown in which the object storage and/or transport pocket 170 is illustratively supported by a pair of elongated support members 182A, 182B, e.g., rods, bars or brackets, passing through the openings 176A, 176B respectively. The rods, bars or brackets 182A, 182B are each illustratively supported at either end thereof and/or at or near the opposed sides of the sleeve 170, such that the object storage and/or transport pocket 170 is suspended by the rods, bars or brackets 182A, 182B to form an object supporting/transporting pocket area 184 between the openings 176A, 176B. In the illustrated embodiment, the seam 187 is positioned on the underside of the pocket 170 so as not to interfere with or abrade objects being carried by the pocket 170.

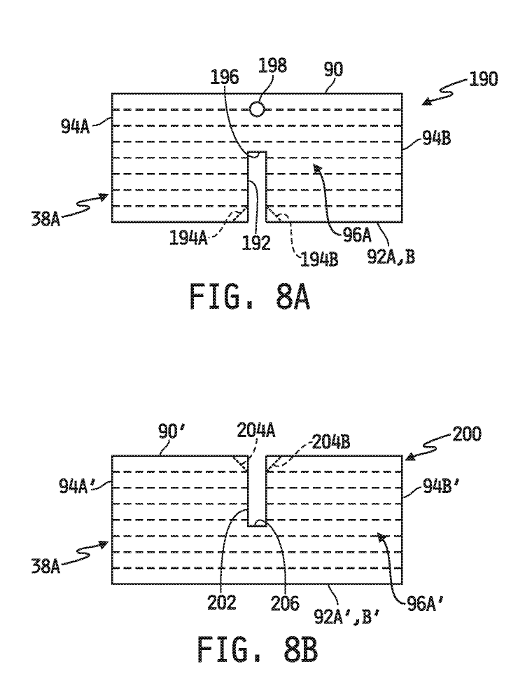

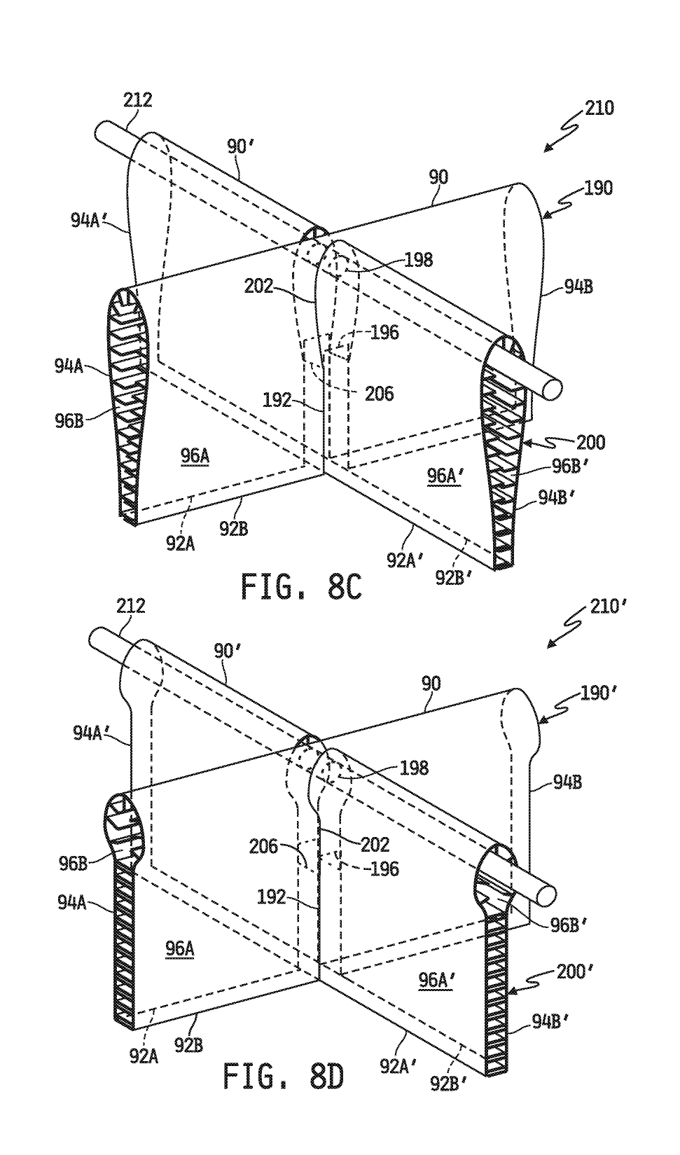

Referring now to FIGS. 8A-8C, a sixth example product is shown in the form of a partition structure 210 that may be used on its own or as part of an array or matrix of such partition structures for separating and/or protecting objects, e.g., during storage and/or shipping. Referring specifically to FIGS. 8A and 8B, the partition structure 210 illustrated in FIG. 8C is a combination of two supportable dividers 190, 210 each illustratively formed from a single-foil ribbed sheet, e.g., a single foil ribbed sheet 38A of FIG. 2B. The divider 190 illustrated in FIG. 8A is initially formed as illustrated and described with respect to FIG. 5A, e.g., by folding the single-foil ribbed sheet 38A along a fold line 90 that is parallel with the longitudinal direction of the elongated support structures 36, i.e., folded along the machine direction of the sheet 38A. As described with respect to FIGS. 5A and 5B, the folded sheet illustrated in FIG. 8A has a sheet section or flap 96A defined between the fold 90, one free end 92A and opposite sides 94A, 94B of the sheet 38A, and another opposing sheet section or flap 96B defined between the fold 90, an opposite free end 92B and the opposite sides 94A, 94B. The divider 200 illustrated in FIG. 8B is likewise initially formed as illustrated and described with respect to FIG. 5A, e.g., by folding the single-foil ribbed sheet 38A along a fold line 90′ parallel with the machine direction of the sheet 38A, and the folded sheet likewise has a sheet section or flap 96A′ defined between the fold 90′, one free end 92A′ and opposite sides 94A′, 94B′ of the sheet 38A, and another opposing sheet section or flap 96B′ defined between the fold 90′, an opposite free end 92B′ and the opposite sides 94A′, 94B′.

The divider 190 illustratively defines an aligned channel or slot 192 through each flap 96A, 96B which extends upwardly toward the fold 90 from the free ends 92A, 92B of the sheet 38A and terminates at a channel end 196 between the fold 90 and the free ends 92A, 92B. In some embodiments, the channel 192 may include angled cutouts 194A, 194B at the free ends 92A, 92B of the sheet 38A for facilitating assembly of the partition 210. In any case, the divider 190 further defines an aligned opening 198 through each flap 96A, 96b just below the fold 90 and which is illustratively aligned with the channel or slot 192.

The divider 200 illustratively defines an aligned channel or slot 202 through each flap 96A′, 96B′ which extends downwardly from the fold 90′ toward the free ends 92A′, 92B′ of the sheet 38A and terminates at a channel end 206 between the fold 90 and the free ends 92A′, 92B′. In some embodiments, the channel 202 may include angled cutouts 204A, 204B at the fold 90′ of the sheet 38A for facilitating assembly of the partition 210.

Referring now specifically to FIG. 8C, the partition structure 210 is illustratively assembled by inserting the slot 202 of the divider 200 into the slot 192 of the divider 190. The fold 90′ of the divider 200 is then advanced toward the fold 90 of the divider 190 until the area of the divider 200 under the fold 90′ is aligned with the opening 198 defined through the divider 190. An elongated support rod, bar or bracket 212 is then advanced into one side 94A′, 94B′ of the divider 200 beneath the fold 90′, then through the opening 198 in the divider 190 and out the other side 94A′, 94B′ of the divider 200. The opposing ends of the support rod, bar or bracket 212 are illustratively supported by a suitable support structure such that the partition structure 210 is suspended by the rod, bar or bracket 212.

It will be understood that the partition structure 210, illustrated and described as including a single divider 190 defining a single slot 192 and opening 198, and a single divider 200 defining a single slot 202, represents only one example partition structure and should not be considered to be limiting in any way. In some alternative embodiments, the divider 190 may define one or more additional slots 192 and aligned openings 198 to accommodate mounting thereto of more than one divider 200 and rod, bar or bracket 212 combinations. Alternatively or additionally, the divider 200 may define one or more additional slots 202 to accommodate mounting thereto of more than one divider 190 and rod, bar or bracket 212 combinations.

In the embodiment illustrated in FIG. 8C, the flaps 96A, 96B of the divider 190 are not bonded together or otherwise attached to each other, and the flaps 96A′, 96B′ of the divider 200 are likewise not bonded together or otherwise attached to each other. The flaps 96A, 96B of the resulting divider 190 are thus billowed, as are the flaps 96A′, 96B′ of the resulting divider 200. In such embodiments, the billowed dividers 190, 200 illustratively provide for increased cushioning and/or secure fit of objects carried between and in contact with the divider walls.

Referring now to FIG. 8D, a seventh example product is shown in the form of another partition structure 210′ that may be used on its own or as part of an array or matrix of such partition structures for separating and/or protecting objects, e.g., during storage and/or shipping. The partition structure 210′ is identical to the partition structure 210 illustrated in FIG. 8C except that at least one or more portions of the flaps 96A, 96B of the divider 190′ are bonded together and at least one or more portions of the flaps 96A′, 96B′ of the divider 200′ are likewise bonded together, e.g., using any one or more of the bonding apparatus and/or techniques illustrated and described with respect to FIGS. 5C-5G. Openings and a corresponding passageway are illustratively provided near the fold 90′ of the divider 200′ to accommodate receipt therein of a rod, bar or bracket 212. While such openings and a corresponding passageway near the fold 90 of the divider 190 are not strictly necessary in this embodiment, such may be provided for consistency with the external profile of the divider 200′. In a variant of the partition structures 210, 210′ illustrated in FIGS. 8C and 8D, only one or the other of the dividers 190, 200 of the partition structure 210 may be replaced with a corresponding one of the dividers 190′, 200′ of the partition structure 210′.

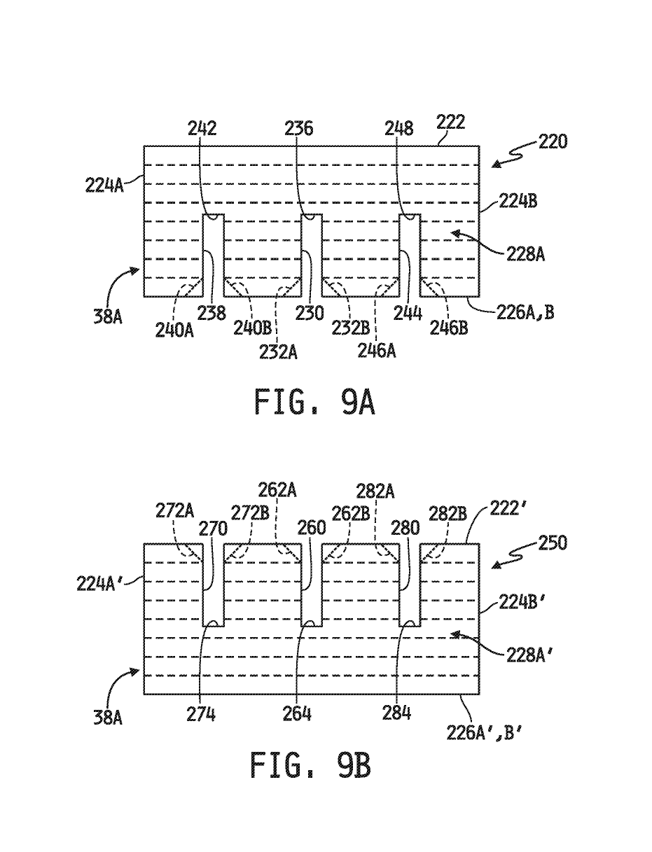

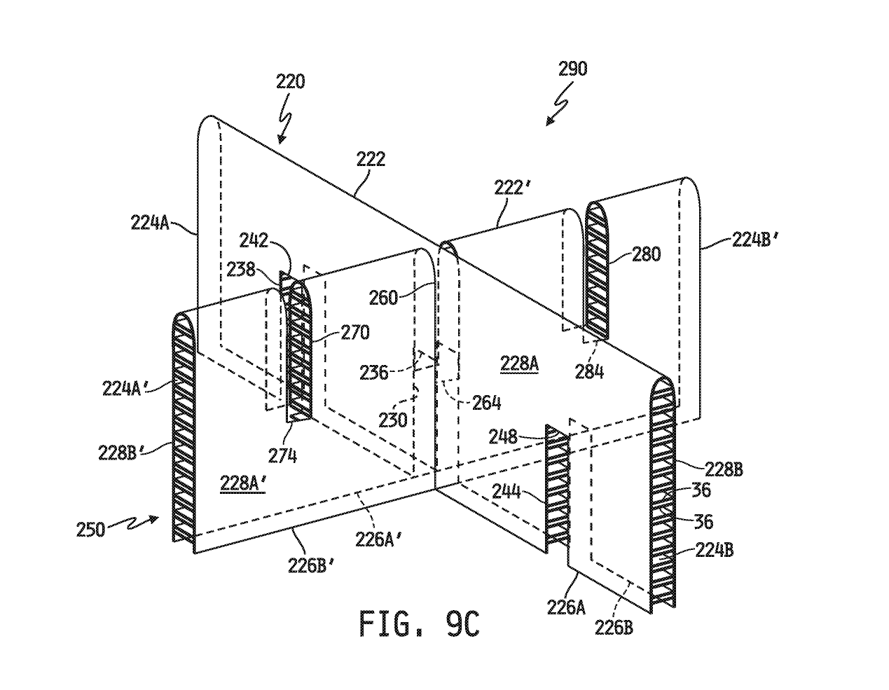

Referring now to FIGS. 9A-9C, an eighth example product is shown in the form of yet another partition structure 290 that may be used on its own or as part of an array or matrix of such partition structures for separating and/or protecting objects, e.g., during storage and/or shipping. Referring specifically to FIGS. 9A and 9B, the partition structure 290 illustrated in FIG. 9C is a combination of two supportable dividers 220, 250 each illustratively formed from a single-foil ribbed sheet, e.g., a single foil ribbed sheet 38A of FIG. 2B. The divider 220 illustrated in FIG. 9A is initially formed as illustrated and described with respect to FIG. 5A, e.g., by folding the single-foil ribbed sheet 38A along a fold line 222 that is parallel with the longitudinal direction of the elongated support structures 36, i.e., folded along the machine direction of the sheet 38A. The folded sheet illustrated in FIG. 8A has a sheet section or flap 228A defined between the fold 22, one free end 226A and opposite sides 224A, 224B of the sheet 38A, and another opposing sheet section or flap 228B defined between the fold 222, an opposite free end 226B and the opposite sides 224A, 224B. The divider 250 illustrated in FIG. 9B is likewise initially formed as illustrated and described with respect to FIG. 5A, e.g., by folding the single-foil ribbed sheet 38A along a fold line 222′ parallel with the machine direction of the sheet 38A, and the folded sheet likewise has a sheet section or flap 228A′ defined between the fold 222′, one free end 226A′ and opposite sides 224A′, 224B′ of the sheet 38A, and another opposing sheet section or flap 228B′ defined between the fold 222′, an opposite free end 226B′ and the opposite sides 224A′, 224B′.

The divider 220 illustratively defines a number, e.g., three shown in FIG. 9A, of aligned and spaced apart channels or slots 230, 238, 244 through each flap 228A, 228B, each of which extends upwardly toward the fold 222 from the free ends 226A, 226B of the sheet 38A and terminates at a channel end 236, 242, 248 respectively between the fold 222 and the free ends 226A, 226B. In some embodiments, one or more of the channels 230, 238, 244 may include angled cutouts 232A, 232B, 240A, 240B and 246A, 246B respectively at the free ends 226A, 226B of the sheet 38A for facilitating assembly of the partition 290.

The 250 illustratively defines a number, e.g., three shown in FIG. 9B, of aligned and spaced apart channels or slots 260, 270, 280, through each flap 228A′, 228B′, each of which extends downwardly from the fold 222′ toward the free ends 226A′, 226B′ of the sheet 38A and terminates at a channel end 264, 274, 284 respectively between the fold 222′ and the free ends 226A′, 226B′. In some embodiments, one or more of the channels 260, 270, 280 may include angled cutouts 262A, 262B, 272A, 272B and 282A, 282B respectively at the free ends 226A′, 226B′ of the sheet 38A for facilitating assembly of the partition 290.

Referring now specifically to FIG. 9C, at least a portion of the flaps 228A, 228B of the divider 220 are illustratively bonded together or otherwise attached to each other, at least a portion of the flaps 228A′, 228B′ of the divider 250 are likewise illustratively bonded together or otherwise attached to each other e.g., using any one or more of the bonding apparatus and/or techniques illustrated and described with respect to FIGS. 5C-5G. In this regard, the channels 230, 238, 244 defined through the divider 220 need not begin at the ends 226A, 226B of the sheet 38A and may alternatively begin at the fold 222, and/or the channels 260, 270, 280 defined through the divider 250 need not begin at the fold 222′ and may alternatively being at the ends 226A′, 226B′ of the sheet 38A. In any case, the partition structure 290 is illustratively assembled by inserting one of the slots of the divider 250, e.g., the slot 260, into one of the slots of the divider 220, e.g., the slot 230. The terminal end 264 of the slot 260 is then advanced toward the terminal end 236 of the slot 230 until the folds 222, 222′ and/or ends 226A, 226B, 226A′, 226B′ are aligned.

It will be understood that the partition structure 290, illustrated and described as including a single divider 220 and another single divider 250, represents only one example partition structure and should not be considered to be limiting in any way. In some alternative embodiments, additional dividers 250 may be coupled to the divider 220 and/or additional dividers 220 may be coupled to the divider 250. Alternatively or additionally, the divider 220 may define one or more additional slots to accommodate mounting thereto of one or more additional dividers 250, and/or the divider 250 may define one or more additional slots to accommodate mounting thereto of one or more additional dividers 220.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, while a number of example products have been illustrated and described herein as using one or more single-foil ribbed sheets folded in and along the machine direction, it will be understood that one or more of the single-foil ribbed sheets in any example product described herein may alternatively be folded in and along the cross-machine direction or along some angle relative to the machine or cross-machine direction. As another example, while a number of example products have been illustrated and described herein as using one or more particular single-foil ribbed sheets, e.g., one or more of the single-foil ribbed sheets 38A, 38B, 38C or 38D illustrated in FIGS. 2B-2C, it will be understood that any example product described herein may be implemented using any single-foil ribbed sheet illustrated and/or described herein.

What is claimed is:

1. A method for making single-foil ribbed sheets, comprising:
providing an opposed-foil panel having first and second spaced apart planar foils and a plurality of support members affixed to and between opposed interior surfaces of the spaced apart first and second planar foils such that the plurality of support members define a height between the opposed interior surfaces,
positioning at least one of the opposed-foil panel and a cutting tool, including a blade defining a cutting edge, relative to the other such that at least a portion of the blade extends along a blade plane parallel with planes defined by the first and second planar foils and passing through the plurality of support members or an interface between the plurality of support members and one of the first and second planar foils, and
moving at least one of the cutting tool and the opposed-foil panel such that the cutting edge of the blade passes through the blade plane to produce at least one single-foil ribbed sheet including one of the first and second planar foils and at least a portion of the height of the support members extending away from the interior surface thereof.

2. The method of claim 1, wherein the positioning step comprises positioning the at least one of the opposed-foil panel the cutting tool relative to each other such that the blade plane passes through the interface between the plurality of support members and the second planar foil, and moving the at least one of the cutting tool and the opposed-foil panel produces a single-foil ribbed sheet including the first planar foil and all or most of the height of the plurality of support members extending away from the interior surface thereof.

3. The method of claim 1, wherein the positioning step comprises positioning the at least one of the opposed-foil panel and the cutting tool relative to the other such that the blade plane passes through the plurality of support members between the first and second planar foils, and moving the at least one of the cutting tool and the opposed-foil panel produces two single-foil ribbed sheets each including one of the first and second planar foils and at least a portion of the height of the support members extending away from the interior surface thereof.

4. The method of claim 1, wherein the portion of the blade that extends along the blade plane spans the opposed-foil panel, and moving the at least one of the cutting tool and the opposed-foil panel produces the at least one single-foil ribbed sheet in a single pass of the blade through the blade plane.

5. The method of claim 1, wherein the plurality of support members extend in a machine direction along and between the interior surfaces of the first and second planar foils and are spaced apart along a cross-machine direction normal to the machine direction,
and wherein the positioning step comprises positioning the at least one of the opposed-foil panel and the cutting tool relative to the other such that moving the at least one of the cutting tool and the opposed-foil panel causes the at least one of the cutting tool and the opposed-foil panel to move toward the other along the machine direction,
and wherein the method further comprises driving the cutting edge of the blade along the blade plane in the cross-machine direction as the cutting edge of the blade passes through the blade plane along the machine direction to produce the at least one single-foil ribbed sheet.

6. A single-foil ribbed sheet product, comprising:
a single-foil ribbed sheet formed from an opposed-foil panel having first and second spaced apart planar foils and a plurality of support members affixed to and defining a height between opposed interior surfaces of the spaced apart first and second planar foils, by severing at least the second planar foil from the opposed-foil panel along a plane parallel with a plane defined by the first and second planar foils to produce the single-foil ribbed sheet comprising the first planar foil and some or all of the height of the plurality of support members extending away from the interior surface thereof, and
a product made from one or more of the single-foil ribbed sheet.

7. The single-foil ribbed sheet product of claim 6, wherein the plurality of support members of the single-foil ribbed sheet comprises a plurality of elongated support members extending in a first direction along the interior surface of the first planar foil and spaced apart along a second direction normal to the first direction,
and wherein the product is a fluid directing apparatus comprising a body defining a surface with an exterior surface, opposite the interior surface, of the first planar foil mounted thereto such that the some or all of the height of the plurality of support members extending away from the interior surface of the first planar foil define elongated channels between the spaced apart support members to direct fluid flow therethrough along the surface of the body.

8. The single-foil ribbed sheet product of claim 6, wherein the plurality of support members of the single-foil ribbed sheet comprises a plurality of elongated support members extending in a first direction along the interior surface of the first planar foil and spaced apart along a second direction normal to the first direction, each of the plurality of support members extending away from the interior surface of the first planar foil to an exposed terminal surface,
and wherein the product is a fluid directing apparatus comprising a body defining a surface with the exposed terminal surfaces of the plurality of elongated support members mounted thereto to define elongated, closed channels between the spaced apart support members, the interior surface of the first planar foil and the surface of the body to direct fluid flow therethrough.

9. The single-foil ribbed sheet product of claim 6, wherein the first planar foil is a flexible planar foil and each of the plurality of support members extend away from the interior surface of the flexible planar foil to an exposed terminal surface,
and wherein the product is a flexible packing mat for protecting a cylindrical object during shipping or storage, the flexible packing mat comprising the flexible planar foil sized to wrap about the cylindrical object with the exposed terminal surfaces of the plurality of support members in contact with the cylindrical object such that the flexible planar foil is spaced apart from the cylindrical object by the plurality of support members.

10. The single-foil ribbed sheet product of claim 9, wherein the flexible planar foil of the flexible packing mat defines a first side and a second side opposite the first side,
and wherein the first and second sides are joined together at least partially along a length thereof with the flexible packing mat wrapped about the cylindrical object to secure the flexible packing mat about the cylindrical object.

11. The single-foil ribbed sheet product of claim 6, wherein the opposed-foil panel from which the single-foil ribbed sheet is formed is made of plastic, and wherein the first planar foil is a flexible planar foil and each of the plurality of support members extend away from the interior surface of the flexible planar foil
and wherein the product is a supportable divider for separating items during shipping or storage, the supportable divider comprising the single-foil ribbed sheet folded along a fold line defined along the flexible planar foil to produce opposing flaps on either side of the fold line with each flap having an interior surface defined by the interior surface of a respective portion of the flexible planar foil defining the flap and with the interior surfaces of the opposing flaps facing each other, the interior surfaces of the opposing flaps thermally bonded together at one or more locations leaving an opening adjacent to and along the fold line which extends completely through the folded, single-foil ribbed sheet, the opening sized to receive an elongated support member therethrough for supporting the supportable divider.

12. The single-foil ribbed sheet product of claim 11, wherein the plurality of support members of the single-foil ribbed sheet comprises a plurality of elongated support members extending in a first direction along the interior surface of the first planar foil and spaced apart along a second direction normal to the first direction.

13. The single-foil ribbed sheet product of claim 11, wherein the opposing flaps are pressed together in contact at one or more locations thereof such that the plurality of support members extending away from the interior surfaces of each flap interdigitate, the opposing flaps thermally bonded together at the one or more locations by thermally bonding at least corresponding ones of the plurality of interdigitated support members at the one or more locations to the interior surfaces of the opposing flaps.

14. The single-foil ribbed sheet product of claim 11, wherein a length of the divider is defined by cutting opposing ends of the single-foil panel, after folding the single-foil ribbed sheet along the fold line, with a cutting tool which generates sufficient heat during cutting of the opposed flaps together to thermally bond the opposed flaps along at least portions of opposing ends thereof.

15. The single-foil ribbed sheet product of claim 11, further comprising the elongated support member extending through the opening of the supportable divider, the elongated support member supportable at either end thereof or at or near the opposing sides of the divider such that the supportable divider is suspended by the elongated support member.

16. The single-foil ribbed sheet product of claim 6, wherein the opposed-foil panel from which the single-foil ribbed sheet is formed is made of plastic, and wherein the first planar foil is a flexible planar foil and each of the plurality of support members extend away from the interior surface of the flexible planar foil,
and wherein the product is an object storage or transport sleeve for supporting items during shipping or storage, the sleeve comprising the single-foil ribbed sheet folded along a first fold line defined along the flexible planar foil and along a second fold line defined along the flexible planar foil and parallel with and spaced apart from the first fold line to form a first flap between the first fold line and one end of the single-foil ribbed sheet and a second flap between the second fold line and an opposite end of the single-foil ribbed sheet, the first flap having an interior surface defined by the interior surface of a portion of the flexible planar foil defining the first flap, the second flap having an interior surface defined by the interior surface of a portion of the flexible planar foil defining the second flap, and with the interior surface of the first flap facing a first portion of the interior surface of the flexible planar foil between the first and second fold lines and the interior surface of the second flap facing a second portion of the interior surface of the flexible planar foil between the first and second fold lines adjacent to the first portion of the interior surface of the flexible planar foil, the interior surfaces of the first flap and the first portion of the flexible planar foil thermally bonded together at one or more locations leaving a first opening adjacent to and along the first fold line which extends completely through the folded single-foil ribbed sheet, the first opening sized to receive a first elongated support member therethrough for supporting the object storage or transport sleeve, and the interior surfaces of the second flap and the second portion of the flexible planar foil thermally bonded together at one or more locations leaving a second opening adjacent to and along the second fold line which extends completely through the folded, single-foil ribbed sheet, the second opening sized to receive a second elongated support member therethrough for supporting the object storage or transport sleeve.

17. The single-foil ribbed sheet product of claim 16, further comprising the first and second elongated support members each extending through a corresponding one of the first and second openings of the object storage or transport sleeve, each of the pair of elongated support members supportable at either end thereof or at or near the opposing sides of the sleeve such that the sleeve is suspended by the pair of elongated support members.

18. The single-foil ribbed sheet product of claim 16, wherein the first flap and the first portion of the flexible planar foil are pressed together in contact at one or more locations thereof such that the plurality of support members extending away from the interior surfaces thereof interdigitate, the first flap and the first portion of the flexible planar foil thermally bonded together at one or more first locations by thermally bonding at least corresponding ones of the plurality of interdigitated support members at the one or more first locations to the interior surfaces of the first flap and the first portion of the flexible planar foil,
and wherein the second flap and the second portion of the flexible planar foil are pressed together in contact at one or more locations thereof such that the plurality of support members extending away from the interior surfaces thereof interdigitate, the second flap and the second portion of the flexible planar foil thermally bonded together at one or more second locations by thermally bonding at least corresponding ones of the plurality of interdigitated support members at the one or more second locations to the interior surfaces of the second flap and the second portion of the flexible planar foil.

19. The single-foil ribbed sheet product of claim 6, wherein the opposed-foil panel from which the single-foil ribbed sheet is formed is made of plastic, and wherein the first planar foil is a flexible planar foil and each of the plurality of support members extend away from the interior surface of the flexible planar foil,
and wherein the product is a partition structure for separating items during shipping or storage, the partition structure comprising:
a first single-foil ribbed sheet folded along a first fold line to produce opposing first flaps on either side of the first fold line with each first flap having an interior surface defined by the interior surface of a respective portion of the flexible planar foil defining the first flap and with the interior surfaces of the opposing first flaps facing each other, the first single-foil ribbed sheet defining an opening therethrough adjacent to the first fold line and a first slot therethrough aligned with and extending toward the opening from opposed free ends of the opposing first flaps, and
a second single-foil ribbed sheet folded along a second fold line to produce second opposing flaps on either side of the second fold line with each second flap having an interior surface defined by the interior surface of a respective portion of the flexible planar foil defining the second flap and with the interior surfaces of the opposing second flaps facing each other, the second single-foil ribbed sheet defining a second slot therethrough extending through and from the second fold line toward the opposed free ends of the opposing second flaps,
wherein the second slot of the second single-foil ribbed sheet is received within the first slot of first single-foil ribbed sheet such that the opening through the first single-foil ribbed sheet aligns with the interior surfaces of the opposed second flaps of the second single-foil ribbed sheet adjacent to the second fold line, the opening sized to receive therethrough, and also along and within the aligned second single-foil ribbed sheet adjacent to the second fold line, an elongated support member for supporting the partition.

20. The single-foil ribbed sheet product of claim 19, wherein at least one of the first opposing flaps and the second opposing flaps are not attached to each other such that the at least one of the corresponding first and second single-foil ribbed sheets forms a billowed divider.
